(19) United States
(12) Patent Application Publication
(10) Pub. No.: US 2026/0199833 A1
(43) Pub. Date: Jul. 16, 2026

(54) DISINFECTANT, GAS ACCUMULATION AND COMBUSTION CONTROL DEVICE

(71) Applicant: NanoSieve, Inc., Miami Beach, FL (US)

(72) Inventor: Gabrielle Abizeid, Miami Beach, FL (US)

(21) Appl. No.: 19/564,144

(22) Filed: Mar. 11, 2026

Related U.S. Application Data
(63) Continuation-in-part of application No. 18/403,969, filed on Jan. 4, 2024.
Application No. 18/403,969 is a continuation-in-part of application No. 17/885,141, filed on Aug. 10, 2022, now abandoned.
Application No. 17/885,141 is a continuation-in-part of application No. 17/525,848, filed on Nov. 12, 2021, now Pat. No. 12,201,935.
Application No. 17/525,848 is a continuation-in-part of application No. 16/994,909, filed on Aug. 17, 2020, now Pat. No. 11,473,794.

(51) Int. Cl. B01D 53/75; B01D 53/04; B01D 53/22; B01D 53/26; B01D 53/86; B01D 53/88; B01D 63/02; B01D 63/10

(52) U.S. Cl. CPC B01D 53/75; B01D 53/0446; B01D 53/0454; B01D 53/229; B01D 53/26; B01D 53/864; B01D 53/8671; B01D 53/8696; B01D 53/885; B01D 63/02; B01D 63/10; B01D 2053/224; B01D 2257/108; B01D 2257/2047; B01D 2257/304; B01D 2257/504; B01D 2257/702; B01D 2257/80; B01D 2257/93; B01D 2258/06; B01D 2259/4508

(57) ABSTRACT

A gas accumulation and combustion control device combining a sorption system, a ventilation system, a control system, and sensor system, with the sensor system configured to detect gas contaminants, transmit a gas detection signal to the control system, the control system configured to adjust the ventilation system based on the gas detection signal, the ventilation system configured to draw the contaminated air in from the atmosphere and lead it toward the sorption system, which in turn is configured to adsorb or absorb the gas contaminants.

### PRIORITY

This application is a continuation-in-part of and claims priority to U.S. non-provisional application Ser. No. 18/403,969, filed Jan. 4, 2024, which in turn is a continuation-in-part of and claims priority to U.S. non-provisional application Ser. No. 17/885,141, filed Aug. 19, 2022, which in turn is a continuation-in-part of and claims priority to U.S. non-provisional application Ser. No. 17/525,848, filed Nov. 12, 2021, which in turn is a continuation-in-part of and claims priority to U.S. non-provisional application Ser. No. 16/994,909 filed Aug. 17, 2020, now patent U.S. Pat. No. 11,473,794B2, issued Oct. 18, 2022, priority of which is also claimed by the present application. All referenced applications are incorporated herein in their entirety as if restated in full.

### BACKGROUND

The two main dangers of gas accumulation, whether in residential, commercial, laboratory, or industrial settings, include their flammability and their toxicity.

Fires are put out with great difficulty and expense, and cause damage not only to property, which can be extensive, but also to human (and animal) life. A gas fire is exceptionally dangerous, because gas not only burns but may combust, an effect which causes a sudden and massive spread of fire. Since gas is capable of squeezing through cracks or gaps and permeate through different surface, gas may spread from room to room in a manner much faster than traditional fires, which rely on solid media, such as wood. A gas fire is also easier to start than a traditional fire, since gas ignites instantly while solid media such as wood take longer. Further, since gas travels in a near random path, or else is blown about by even low-level currents, gas may enter areas where small fires would otherwise be acceptable due to their controlled nature and distance from more obviously flammable material, such as paper or wood. A person lighting a cigarette or a candle may not realize that they are triggering an explosion because of a stream of gas which has trickled in and accumulated in their room.

While the toxicity of gas generally does not affect property, it can be harmful, even lethal, to living organisms, such as people and animals. Even if a toxic gas is not flammable, the accumulation of gas, which is often undetected, may enter a living being's respiratory and circulatory system, killing otherwise healthy cells, particularly cells in the lungs, esophagus, nasal passage, and brain. Certain gases, such as carbon monoxide, may cause the types of damage described without even requiring a build-up, and such gases are immediately dangerous even in miniscule amounts.

Importantly, flammable and toxic gases are frequently odorless; and when they do have odors, those odors may be very faint. People have varying degrees of sensitivity to odors, and so gases that might be detected by one person may not be detected by another. Even if a person is sensitive to smells, the slow build up of gas may unconciously adjust the person's sensitivity, such that a gas they would otherwise be detected may be undetected if the person has remained in the location during the gas build up.

What is needed is a device that can detect the presence of gas, isolate it through sorption, delay the negative effects of gas build-up through partial and/or continuous sorption, alert a location custodian of its presence, address a max sorption capacity event, and be easy to handle and control. Such a device may nullify the danger for small amounts of gas, or give an attended time to take remedial action, such as opening a window, calling the fire department, and/or evacuating the premises.

### SUMMARY

The gas accumulation and combustion control device comprises a sorption box designed to hold a sorption system, a ventilation system, a sensor system, and a control system. The ventilation system is in electrical communication with the control system, which in turn is in informational communication with the sensor system.

The sorption box is essentially an enclosure against an atmosphere surrounding the sorption box. The atmosphere may be a confined space, such as a room, or an open space, such as the outdoors. It has at least one or more passage walls, and one or more pass-through walls, which together form an internal cavity.

The pass-through walls are configured to permit air to flow between the cavity and the atmosphere, and the passage walls, which span from one pass-through wall to the other, is designed to contain the various systems.

The systems are configured to intelligently extract gas contaminants from the environment by actively accelerating air flow into the cavity and then absorbing or adsorbing the gas contaminants by means of sorption material.

In certain embodiments, the device comprises one or more directional inlets configured to face toward an expected gas dispersion pattern originating from a leak source. Such orientation may be achieved through adjustable intake assemblies, articulated mounts, or fan orientation mechanisms. In some implementations the control system determines the likely dispersion direction based on sensor measurements and adjusts inlet orientation accordingly so that incoming contaminated air is preferentially drawn from regions of higher gas concentration.

Additional embodiments relate to (additional) systems and methods for gas separation, purification, and recovery, including embodiments making use of polymeric and inorganic membranes, nanosieve structures, catalytic components, and hybrid arrangements with adsorption-based units. The systems described herein are suitable for industrial processes involving hydrogen, natural gas, biogas, syngas, and other mixed gas streams where selective recovery and purification are desired.

In certain embodiments, membrane modules are configured as hollow-fiber bundles, comprising thousands of fine polymeric capillaries arranged within a cylindrical pressure vessel. The contaminated air stream (i.e., the stream containing the gases requiring separation) may be introduced on the (external) shell side or the (hollow interior) bore side of the hollow fibers, with permeate collected internally or externally depending on the design. Hollow-fiber modules provide high packing density allowing for maximum surface area, low stream resistance and consequently a minimal pressure drop, and robust scalability, and are widely used for separations such as hydrogen recovery, carbon dioxide removal, and nitrogen generation.

In addition to membrane-based hollow fiber modules, hollow fiber structures may be employed as sorbent contactors. Such hollow fiber sorbents comprise porous fibers whose matrix incorporates or is coated with adsorptive materials, such as zeolites, activated carbons, metal-organic frameworks (MOFs), or amine-functionalized polymers. When bundled into shell-and-tube modules, these fibers form structured beds for pressure swing adsorption (PSA), temperature swing adsorption (TSA), or related cycles. The fiber geometry confers advantages including enhanced mass and heat transfer due to thin walls and high surface-area-to-volume ratio, the ability to circulate heating or cooling fluid through the lumens to manage adsorption heat effects, reduced pressure drop compared to packed pellets, and improved mechanical stability against settling or channeling. As a result, hollow fiber sorbent modules may serve as compact, efficient adsorption units, enabling rapid cycles, improved energy efficiency, and deployment in applications such as post-combustion CO2 capture, syngas conditioning, or mobile capture platforms.

In addition to hollow fiber sorbents, adsorption units may be realized as conventional packed beds or as structured beds. A packed bed generally comprises a vessel filled with discrete pellets, beads, granules, or extrudates of adsorptive material, through which the gas stream passes in bulk flow. Packed beds are widely used in PSA and TSA processes due to their simplicity and established manufacturing base, though they may suffer from drawbacks such as pressure drop, bed settling, and thermal gradients. A structured bed, by contrast, refers to a configuration in which the sorbent material is formed or arranged into an ordered geometry, such as monoliths, laminates, foams, or hollow fiber bundles. Structured beds provide enhanced mass transfer, reduced pressure drop, and improved thermal management relative to conventional packed beds. Both packed and structured bed formats are suitable for use in the gas separation and purification systems disclosed herein, and may be selected based on the application, available sorbent materials, and desired cycle performance.

In further embodiments, the membrane elements may be provided in spiral-wound configuration. Such modules may contain permeate spacers, which are thin porous layers placed between the two flat membrane sheets, and feed spacers, which are thin, mesh-like plastic screens that sit between two sets of flat membrane sheets. The flat-sheet membranes are arranged with feed spacers and permeate spacers to form leaf-like envelopes, (with the permeate spacers within each envelope and the feed spacers between envelopes) which are then rolled around a central collection tube. The feed spacers operate as nets or grids, creating open channels so that the feed gas can flow evenly along the membrance surface while preventing the membrane sheets from collapsing against each other. The permeate spacers operate as drains by providing a pathway for permeate (the gas or liquid that passes through the membrane) to move laterally across the envelope, guiding the permeate toward the open edge of the envelope, where it can enter the central collection tube. The feed stream flows axially through channels formed by the feed spacers, while permeate passes through the membrane sheets into the envelopes and spirals inward toward the central tube. Spiral-wound membranes provide a compact form factor with a high ratio of membrane surface area to module volume and can be installed as replaceable elements within pressure vessels. Although more structural fragile than hollow-fiber bundles, spiral-wound membranes are widely applied in gas separation processes, including CO₂ removal from natural gas, nitrogen generation, hydrogen recovery, and biogas upgrading.

Gas transport across membranes is governed by a partial pressure gradient of the permeating species between the feed side and the permeate side. The driving force may be established by compressing the feed stream to an elevated pressure, by maintaining the permeate side under vacuum, or by a combination thereof. In typical operation, a feed compressor supplies sufficient pressure to ensure adequate flux through the membrane, while a vacuum pump may be employed on the permeate side to further enhance selectivity and recovery. Unlike cyclic adsorption systems, membrane units do not require swing-based regeneration, yet they remain dependent on the applied pressure differential to sustain separation performance.

As used herein, a “pressure differential generator” refers to one or more components configured to create a pressure difference across a separation element, such as a membrane or adsorption bed. Examples include feed-side compressors to elevate inlet pressure, permeate-side vacuum pumps to reduce outlet pressure, or combinations thereof. Such devices sustain the partial pressure gradient or pressure swing necessary to drive selective gas transport or adsorption-desorption cycles. In certain embodiments, the system further comprises a pressure differential convection generator configured to induce bulk movement of ambient air or contaminated gas streams into and through the device. The pressure differential convection generator may comprise one or more of a pump, compressor, blower, fan, or vacuum pump configured to create a pressure gradient between the surrounding atmosphere and the interior of the enclosure. By establishing such a pressure gradient, the device actively draws dispersed gas species toward the inlet region of the system and through downstream treatment components such as humidity control units, membrane modules, catalytic elements, or sorption beds. In certain implementations, multiple convection-generating components may operate cooperatively, including inlet blowers, outlet vacuum pumps, or compressors positioned along the gas pathway.

The membrane materials may be selected from advanced polymers, inorganic substrates, or hybrid composites. Examples may include polysulfones, polyimides, and cellulose acetates. Inorganic materials may include zeolite or silica-based structures, ceramic supports, and glassy or metallic membranes. Hybrid materials may further include polymer-inorganic composites, combining mechanical durability with tailored specificity as to the selection of molecules for pass-through.

In certain embodiments, the membranes may comprise nanoscale sieving structures, enabling separations that surpass the permeability-selectivity trade-off typically associated with polymeric systems. Such nanosieves provide pore channels on the order of molecular dimensions, facilitating discriminative transport of gases such as hydrogen, carbon dioxide, oxygen, nitrogen, and light hydrocarbons. Transport mechanisms may include molecular sieving, solution-diffusion, and facilitated transport mediated by functional groups incorporated into the nanosieve.

Beyond conventional polymeric materials, membranes may incorporate emerging nanosieve structures that surpass the permeability-selectivity trade-off described by the Robeson upper bound. These include layered graphene oxide nanosieves, which provide angstrom-scale channels for molecular transport; metal- organic framework (MOF) membranes, offering highly tunable pore chemistries; and thin-film composite nanosieves, in which a selective nanoscale layer is supported on a porous substrate to maximize flux. Such materials have demonstrated hydrogen, carbon dioxide, and hydrocarbon separations with enhanced selectivity and permeance, thereby enabling process intensification in industrial gas recovery and purification.

The use of membranes offers significant advantages compared to conventional pressure swing adsorption (PSA) or vacuum swing adsorption (VPSA) systems. Notably, membrane modules operate continuously under a pressure differential, while adsorption beds require cyclical pressurization, depressurization, and regeneration. The absence of regeneration cycles in membrane systems results in a simpler mechanical design, decreased energy usage, and consequentially reduced manufacturing and maintenance costs.

In certain embodiments, membrane modules may be deployed in a hybrid arrangement with adsorption units. For example, a membrane stage may be used to perform an initial separation step, reducing the concentration of an undesired gas component to a moderate level, followed by a pressure swing adsorption (PSA) or vacuum swing adsorption (VPSA) unit that further purifies the gas stream. Alternatively, or additionally, adsorption stages may be placed upstream to the membranes in order to reduce heavy or condensable impurities, while membrane modules downstream provide continuous removal of lighter gases, thereby providing the final purification. Such combinations allow the system to leverage the continuous operation and compactness of membranes together with the selectivity parameters of adsorbants.

Membrane-based systems may further be specifically configured for hydrogen recovery, carbon dioxide capture, and separation of oxygen, nitrogen, and hydrocarbons. In hydrogen recovery, membranes may be designed for stability under reducing conditions (i.e., environments rich in reducing elements which tend to damage most membrances), while for carbon dioxide capture, membranes may be selected for high CO₂/N₂ selectivity, chemical resistance, and durability against acid, moisture, etc. For oxygen-nitrogen separation, polymeric membranes may be configures specifically for differential solubility of oxygen relative to nitrogen based on the element sizes and polarities.

In many operational environments, particularly battery enclosures or industrial process equipment, the incoming gas stream may comprise mixtures of multiple gaseous species simultaneously. Such mixtures may include combinations of hydrogen, carbon monoxide, methane, water vapor, and ambient air. In practical scenarios the feed stream entering the remediation device may contain two or more of these gases concurrently, and the device is configured to process such mixed streams through catalytic conversion, membrane separation, humidity control, and/or sorption.

High-selectivity modules may be employed for biogas upgrading, i.e., separating methane from carbon dioxide, while other membrane series are optimized for hydrogen recovery from the off-gas streams in refineries. Modular skid-mounted designs enable scalability, with multiple cartridges or modules assembled to match the volumetric gas stream flow rates of refineries or other processing plants.

The separation systems described herein may be applied to natural gas upgrading, refinery gas purification, syngas conditioning, hydrogen recovery from steelmaking off-gas, ammonia synthesis purge gas treatment, and biogas upgrading. They may also be adapted for environmental control in battery enclosures or other confined spaces where hydrogen accumulation may pose safety concerns.

In battery-related environments and other confined industrial settings, the gas stream entering the device may comprise a mixture including hydrogen, carbon monoxide, methane, water vapor, and ambient air. Such mixtures may arise during battery venting events, electrolyte decomposition, or associated electrical faults. In many practical scenarios the incoming stream contains at least two of these components simultaneously. The systems described herein are configured to process such mixed streams through catalytic conversion, humidity control, membrane separation, or sorption processes in order to reduce flammable or toxic gas concentrations.

The systems described herein may be further combined with ancillary process steps such as compression, cooling, and dehydration, enabling integration into larger chemical or energy processing schemes. Downstream utilization of the purified streams may include fuel cell supply, ammonia synthesis feedstock preparation, or pipeline-quality natural gas injection.

In certain embodiments, the separation system may further comprise a catalytic component configured to promote reactions involving hydrogen and hydrocarbons such as methane. The catalytic element may be realized as a structured support, such as a titanium or ceramic lattice, coated with a thin layer of metal oxide and a catalytic metal such as platinum. Depending on the catalyst formulation, the reaction may occur at ambient temperature or may require elevated temperature to proceed efficiently. Accordingly, the component may optionally incorporate a heating element to initiate or accelerate catalytic activity under cooler conditions, while operating passively once sufficient thermal conditions are obtained. Unlike conventional automotive catalytic converters or nuclear passive autocatalytic recombiners (PARs), the disclosed catalytic component is specifically adapted for integration with membrane and sorption-based gas separation systems, and may be designed to address multi-component industrial or battery-related gas environments.

The catalytic element may be positioned either upstream or downstream of sorption columns or membrane modules. When placed downstream, the catalytic component serves to react residual hydrogen while carbon monoxide and methane are preferentially removed by adsorption. When positioned upstream, the catalytic element may oxidize hydrogen and hydrocarbons to form water vapor and carbon dioxide, which can then be selectively removed in subsequent adsorption or membrane stages. The positioning of the catalytic stage may therefore be selected based on desired handling of carbon dioxide and water, as well as the operational sequence of the purification process.

As used herein, a “structured support” for a catalytic component refers to a three-dimensional scaffold or lattice, such as a ceramic monolith, metallic mesh, or porous titanium framework, upon which catalytic materials are deposited. The structured support provides high surface area, mechanical durability, and defined flow paths for the gas stream. The catalytic coating may include metal oxides such as alumina or ceria, in combination with metals such as platinum, palladium, or nickel, enabling reactions such as hydrogen oxidation. Depending on the formulation, the catalyst may be active at ambient temperature or may require heating to elevated temperature. Accordingly, in some embodiments, the support is integrated with a heating element to facilitate reaction initiation or acceleration under cool conditions.

In additional embodiments, the system may include a humidity-control adsorbent dedicated to the removal of water vapor from the gas stream prior to entry into the primary sorption or membrane stages. By preventing excess humidity from contacting downstream adsorbents, the lifetime and adsorption capacity of carbon dioxide sorbents may be preserved. Such humidity-control layers may be realized using zeolites, silica gels, or other high-capacity desiccants, and may be configured as a preliminary guard bed integrated into the overall purification assembly.

In certain embodiments, multiple humidity control units may be deployed at different stages of the gas-processing pathway. For example, a first humidity control unit may be positioned upstream of catalytic or separation modules in order to remove ambient moisture before the gas stream encounters reactive or adsorptive materials. A second humidity control unit may be positioned downstream of catalytic conversion stages to remove water vapor generated by oxidation reactions, such as the catalytic oxidation of hydrogen or hydrocarbons to form water vapor and carbon dioxide. By distributing humidity-control stages along the gas pathway, the system preserves the adsorption capacity of downstream sorbents and prevents water accumulation within membrane or catalytic components.

The disclosed catalytic and membrane-adsorption systems may be applied in diverse industrial and safety contexts. In battery enclosures, where multi-component gas mixtures including hydrogen, carbon monoxide, and hydrocarbons may arise, the catalytic element provides an immediate mitigation strategy for hydrogen while adsorption and membrane modules polish (purify) the gas stream. In other implementations, the system may be adapted for environments where hydrogen leakage alone is the dominant concern, in which case a combination of ventilation and catalytic conversion may suffice. Such flexibility allows tailoring of the system architecture to specific safety, recovery, and purification needs.

As used herein, the term “membrane module” refers to a structured assembly of one or more membranes enclosed within a pressure-retaining housing or vessel, configured to effect gas separation under a pressure differential. Exemplary configurations include hollow-fiber bundles, in which thousands of polymeric capillaries are arranged within a cylindrical shell, and spiral-wound elements, in which flat-sheet membranes are arranged with feed spacers and permeate spacers into leaf-like envelopes rolled around a central collection tube. A membrane module may further comprise flow distributors, seals, collection manifolds, and other support components necessary to direct feed, permeate, and retentate streams. The term “membrane module” therefore encompasses any engineered form of membrane assembly that provides a defined flow path and continuous separation capability under pressure, unless otherwise specified.

In the context of the present disclosure, a “gas stream handling arrangement” refers to the physical conduits, manifolds, and valve assemblies that direct the flow of gas streams between components of the system. Such arrangements provide for the introduction of mixed gas feed, routing of streams into membrane or adsorption modules, and separate collection of purified and impurity-enriched streams. By integrating valving and conduit architecture, the gas stream handling arrangement enables continuous or cyclic processing of the gas mixture, depending on whether the separation relies on membrane-driven continuous flow or swing adsorption cycles.

For purposes of clarity, the term continuous processing as applied to membrane-based systems refers to the unbroken passage of a gas stream through conduits, inlets, outlets, and membrane modules without the need for cycling, regeneration, or flow interruption. In such arrangements, the conduits and outlet structures are configured to maintain a steady differential in partial pressure across the membrane surfaces, thereby sustaining uninterrupted separation while avoiding cyclic pressurization and depressurization sequences typical of adsorption beds.

As used herein, the term packed bed refers to an adsorption configuration in which granular or pelletized adsorbent materials, such as zeolites, carbons, or metal-organic frameworks, are randomly filled into a column, vessel, or contactor volume. The irregular packing provides a network of void spaces through which the process gas flows while contacting the sorbent surfaces. In contrast, the term structured bed refers to an adsorption configuration in which the sorbent materials are arranged in an ordered geometry, such as coated monolith channels, hollow fibers, or stacked laminates, thereby producing well-defined flow channels that reduce pressure drop, mitigate channeling, and enhance mass and heat transfer.

With respect to hybrid catalytic and membrane systems, the positioning of the catalytic component relative to the membrane module may be arranged in either sequential order. In one embodiment, the gas stream first encounters the catalytic element, which reacts with hydrogen or hydrocarbons to produce water and carbon dioxide, after which the membrane module removes the resultant components. In another embodiment, the gas stream first passes through a membrane module for preliminary separation, with the catalytic stage located downstream to consume residual reactive gases. Both upstream and downstream configurations are within the scope of the present disclosure, and the arrangement may be selected according to the desired handling of hydrogen, carbon monoxide, carbon dioxide, and water vapor.

### First Catalytic Sequence

In one embodiment, a first catalytic sequence is provided in which a catalytic component is positioned downstream of the sorption columns. The process begins with an inlet gas stream comprising a dilute concentration of flammable components (for example, hydrogen, methane, and carbon monoxide) mixed with a majority of air. This stream is first passed through a humidity control unit, which employs an adsorbent such as silica gel or 3A zeolite under low-temperature conditions to selectively remove water vapor. The inclusion of this humidity control step distinguishes the present embodiment from earlier designs, and provides a significant improvement in adsorption efficiency by preventing premature saturation of the downstream sorbent materials.

Following humidity reduction, the conditioned air stream is directed to one or more sorption columns. These columns operate to adsorb methane and carbon monoxide from the gas stream. By removing these higher-energy hydrocarbons, the sorption step ensures that the remaining hydrogen-enriched portion of the stream is more effectively handled in the subsequent catalytic stage. Depending on the operational requirements, either a single column or a plurality of columns may be used, with valving arrangements to allow for parallel or alternating use.

Downstream of the sorption stage, the effluent gas stream—containing primarily hydrogen and air—is directed into a catalytic converter. In the present embodiment, the catalytic converter is configured to promote the reaction of hydrogen with oxygen to yield water vapor and heat according to the reaction 2H₂+O₂→2H₂O (g)+heat. The catalytic component may optionally include a heater element to enhance initiation and sustain reaction kinetics at low ambient temperatures, though operation without supplemental heating is also contemplated.

The catalytic converter of this first sequence is specifically employed for the removal of hydrogen. In contrast, methane and carbon monoxide are substantially managed by adsorption within the upstream columns and are not the primary targets of the catalytic oxidation process. This staged division of functionality—adsorption for CH₄ and CO, catalysis for H₂—provides operational efficiency, extended sorbent life, and improved safety in enclosed spaces. The treated exhaust stream, which now consists mainly of nitrogen, water vapor, and minor quantities of heat energy, is then discharged back into the room or indoor environment at safe levels well below flammability thresholds.

In certain embodiments, the catalytic converter serves as a safety-extending stage that immediately reduces the hazard posed by hydrogen accumulation. Because hydrogen has a very low ignition energy and diffuses rapidly into enclosed spaces, the catalytic oxidation of hydrogen into water vapor provides an immediate hazard mitigation step, even if other flammable gases remain present. By prioritizing hydrogen removal catalytically while carbon monoxide and methane are sequestered in upstream adsorption beds, the system prevents simultaneous buildup of multiple reactive species, thereby extending the operational margin of safety in environments such as battery enclosures, residential rooms, or laboratory spaces.

In addition, this staged treatment permits more flexible handling of collected gases. Whereas adsorbed methane and carbon monoxide may later be released during controlled desorption cycles into collection containers for neutralization or off-site disposal, hydrogen is neutralized in situ and does not require storage. This division of function not only simplifies the logistics of gas collection and disposal, but also reduces the pressure load on collection containers, thereby prolonging their service life and minimizing the likelihood of dangerous over-pressurization events. The combined effect is a hybrid safety-recovery process in which catalytic conversion neutralizes hydrogen instantly, while sorption and controlled desorption manage the longer-term handling of other contaminants.

### Second Catalytic Sequence

In another embodiment, a second catalytic sequence is provided in which the catalytic component is positioned upstream of the sorption columns. In this arrangement, the incoming gas mixture containing hydrogen, carbon monoxide, methane, and air is first directed into a catalytic converter. The catalytic element may be realized in two alternative versions, each addressing a different target species.

In a first version, the catalytic converter operates without a heater. In this configuration, the catalyst promotes the oxidation of hydrogen to water vapor and heat according to the reaction 2H₂+O₂ →2H₂O (g)+heat. This version is particularly suited for safety contexts where hydrogen is the most immediate hazard, as it neutralizes hydrogen before it can accumulate or enter the sorption columns. Because the converter operates passively at ambient conditions, it provides an immediate, low-energy safety mechanism that does not rely on external heating.

In a second version, the catalytic converter incorporates an integrated heater to raise the operating temperature and thereby enable oxidation of hydrocarbons, such as methane, to carbon dioxide and water vapor according to the reaction CH₄+2O₂→CO₂+2H₂O (g). By oxidizing hydrocarbons at the inlet stage, this heated configuration reduces the concentration of combustible gases before they reach the adsorption units. This preemptive conversion adds an additional layer of fire and explosion prevention in environments where methane or other hydrocarbons may be present alongside hydrogen.

Following catalytic conversion in either version, the exhaust stream contains nitrogen, residual oxygen, water vapor, and, in the heated case, newly generated carbon dioxide. Because water vapor reduces the effective CO₂ capture capacity of materials such as calcium oxide, the stream is then passed through a high-temperature humidity-control stage. Suitable sorbents, such as 3A zeolite or activated alumina, operate as durable desiccants at elevated temperature to remove moisture and preserve the CO₂ uptake performance of the downstream sorbents.

The dried stream then enters one or more sorption columns containing high-temperature chemisorptive materials, such as calcium oxide or magnesium oxide, formulated for CO₂ capture under low partial pressure. In this context, CO₂ binding is irreversible: unlike physical adsorption, chemisorption by CaO or MgO does not permit desorption and reuse. Instead, the CO₂ is permanently trapped, ensuring that neither flammable gases nor combustion byproducts are released into the indoor environment.

This upstream catalytic configuration thus represents a complementary counterpart to the First Catalytic Sequence. The unheated catalytic version provides immediate hydrogen removal, while the heated catalytic version extends the process to hydrocarbons. In both cases, subsequent humidity removal and irreversible CO₂ capture safeguard indoor spaces from both explosive risk and toxic buildup. The combination of ventilation, catalytic oxidation (in selectable versions), high-temperature drying, and permanent CO₂ chemisorption is a novel and highly robust integration for safe gas handling in enclosed environments.

In certain embodiments, the outstream from the catalytic converter—whether positioned upstream or downstream of the sorption columns—is further channeled into one or more collection containers. When operating under the first catalytic sequence, the catalytic unit neutralizes hydrogen in situ, while the sorption columns adsorb methane and carbon monoxide. During scheduled desorption cycles, the released CH₄ and CO may be directed through controlled valving into sealed collection canisters. In this way, the catalytic stage improves safety by removing hydrogen immediately, while the collection containers provide a managed storage solution for other gases pending neutralization or disposal.

In the second catalytic sequence, where hydrocarbons are oxidized to carbon dioxide upstream of the sorption beds, the treated outstream—containing primarily CO₂, nitrogen, oxygen, and water vapor—is likewise processed through humidity control before entering chemisorptive CO₂ columns. Although the chemisorption stage permanently binds CO₂, in certain configurations a bypass or bleed stream may be provided to route residual gases into the same class of collection containers used in the first sequence. This provides a harmonized handling scheme in which both sequences ultimately interface with the same safety and storage infrastructure, ensuring that all gaseous byproducts—whether adsorbed, oxidized, or vented—are accounted for within the system.

In other embodiments, the connection to the collection container is made immediately downstream of the catalytic component. For the first catalytic sequence, this permits residual gases—such as unreacted hydrogen or trace hydrocarbons bypassing adsorption—to be vented or directed into storage rather than discharged into the environment. For the second catalytic sequence, this configuration allows a portion of the catalytic exhaust, containing nitrogen, oxygen, and minor residual carbon oxides, to be captured for later analysis or controlled venting.

Additional variations include connections placed downstream of the humidity-control unit. In this case, the outflow into the collection container consists of a moisture-reduced gas stream, thereby preventing condensation or water loading within the container itself. Such positioning may be advantageous where long-term storage of gases is required, as it protects the container contents and extends service life.

Still further, in systems employing multiple sorption columns, the containers may be connected to the outstream of a single dedicated column. For example, one column may be cycled into desorption while others remain in adsorption mode, with the desorbed fraction directed to a collection vessel. This allows for targeted storage of methane, carbon monoxide, or carbon dioxide depending on which sorbent material is undergoing regeneration, and integrates seamlessly with the catalytic sequences described herein.

In one embodiment, the device inlets comprising an opening engaged to a long flexible intake component, such as a tube or hose, to enable the targeting of expected gas leaks and gas dispersion patterns in the atmosphere and/or adjacent to or in proximity to other machines. In one variation, the intake component engages with a cone for expanding the surface area of intake. In another variaiton, the cone is attached directly to the device inlet without the intake component as an intermediary. The gas dispersion pattern may include likely spatial configurations formed by the leaking gas.

In certain embodiments, the device inlets themselves are configured to be oriented toward expected gas dispersion patterns. Such inlets may be mounted on adjustable mounts, articulated joints, or directional intake assemblies enabling the intake openings to face toward a predicted or detected leak source. Orientation may be manually adjusted by an operator or automatically adjusted by the control system in response to signals from gas sensors indicating the direction of highest gas concentration.

### BRIEF DESCRIPTION OF THE DRAWINGS

FIG. 1 shows a gas accumulation and combustion control device.

FIG. 2 shows a sorption box with pass-through walls.

FIG. 3 shows the ventilation system, control system, and sorption system being disposed inside inlet and outlet doors.

FIG. 4 shows sorption chambers and openings.

FIG. 5A-C show various fan configurations.

FIG. 6 is a flowchart showing conversions between fan configurations.

FIG. 7A-C shows the sensor system.

FIG. 8-9 are flowcharts showing system processes.

FIG. 10 shows sensor system configurations.

FIG. 11-13 are flowcharts showing system processes.

FIG. 14 show various configurations of multiple gas accumulation and combustion control devices.

FIG. 15 shows a number of equations that may be used to calculate the volume of the sorption box.

FIG. 16 shows sorption units stacked cylindrically.

FIG. 17 shows sorption units stacked cylindrically.

FIG. 18 shows a sorption unit coupled to an ultra violet light emitter.

FIG. 19 shows a the device featuring collection containers.

FIG. 20a shows the collection container in a compressed or non-expanded state.

FIG. 20b shows the collection container in an expanded state.

FIG. 21 is a flowchart showing an alternating sorption box desorption system process.

FIG. 22 is a flowchart showing a vetilation engagement system process.

FIG. 23 is a flowchart showing a transmit signal system process.

FIG. 24 illustrates a gas remediation system including a pressure differential convection generator, humidity control unit, dual sorption columns, catalytic converter, and vacuum pump configured for gas remediation and sorbent regeneration.

FIG. 25 illustrates an embodiment of a gas remediation system including a ventilation or compression unit, a catalytic converter, a humidity control unit, and sorption columns configured for removal of carbon dioxide and other gases from an ambient air stream.

FIG. 26 illustrates an embodiment of a gas remediation system including a compressor, a membrane separation module, sorption columns, and a vacuum regeneration system.

FIG. 27 illustrates an embodiment of a gas remediation system including a compressor, a membrane separation module, a vacuum pump, and a catalytic converter configured to oxidize hydrogen separated from an incoming gas stream.

### DETAILED DESCRIPTION

The gas accumulation and combustion control device is designed to prevent the accumulation of flammable and toxic gases in a residentical, commercial, laboratory, or industrial setting. Flammable and toxic gases, such as natural gas (90% methane), are also considered greenhouse gases, and the device may also be configured to target greenhouse gases.

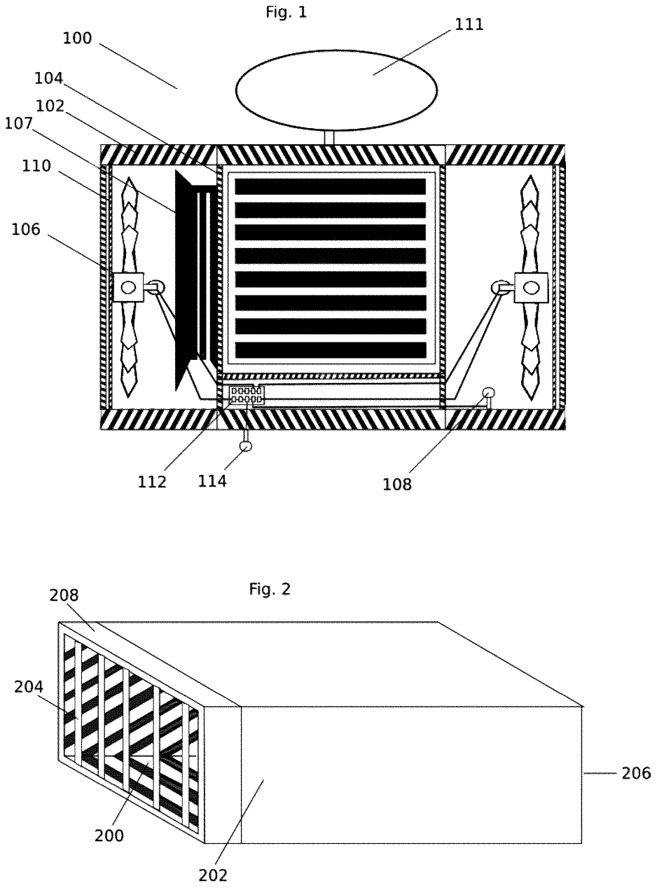

As shown in FIG. 1, the gas accumulation and combustion control device 100 comprises a sorption box 102, a sorption system 104, a ventilation system 106, a compressor 107, a pressure regulator 108, a dust filter 110, a control system 112, a gas collection container 111, and a sensor system 114. These components may be attached to each other mechanically, electrically, wirelessly, directly, and/or indirectly. The attachment may be permanent, temporary, removable, or replaceable.

The sorption box is an enclosure, preferably made of metal, such as aluminum or steel, a hard plastic, or a combination thereof. As shown in FIG. 2, the sorption box may be rectangular or tubular in shape and comprise a cavity 200 surrounded by one or more passage walls 202, and two pass-through walls, including one or more inlet walls 204 and one or more outlet walls 206, with the inlet and outlet walls configured to provide an inlet into and an outlet from the passage walls, respectively. The inlet and outlet walls may be grates in which air, particularly air mixed with flammable or toxic gases, and other small particles are permitted through while preventing entrance into the cavity by larger particles, such as those greater than 1 mm in diameter. In one variation, the inlet and outlet walls may each be coupled to inlet and outlet doors 208, respectively. The inlet and outlet doors may each comprise a set of shutters 210, the shutters oriented to permit fluid flow when in a substantially orthogonal orientation, to block fluid flow when in an orientation substantially in line with the doors, and to permit limited fluid flow when in an orientation between open and closed. The orientation may be controlled by the control system, which will be described below. The inlet and outlet doors may be slidably or hingedly attached to the inlet and outlet walls and configured to seal the inlet and outlet walls.

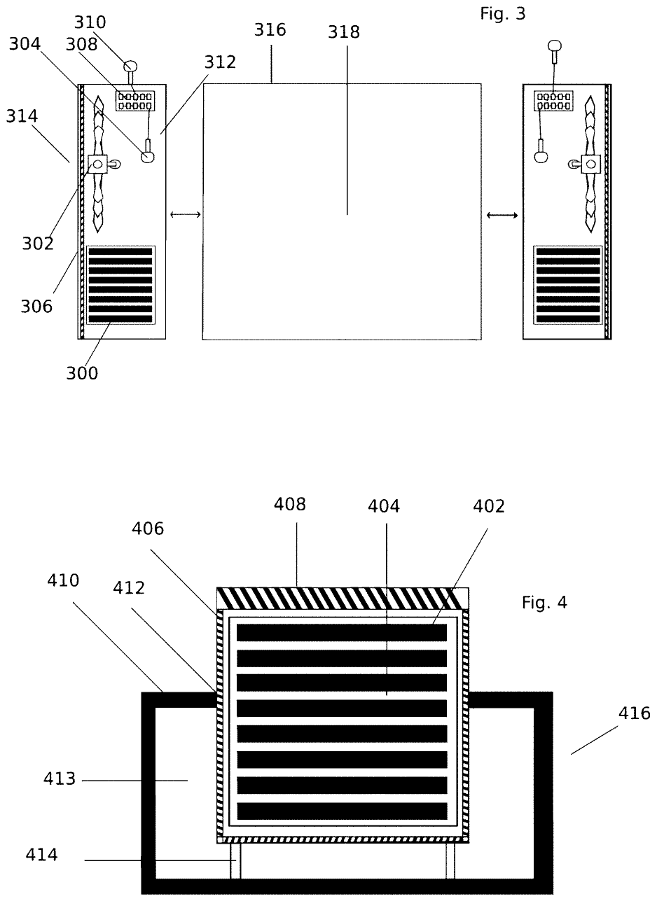

In one variation, as shown in FIG. 3 the sorption system 300, ventilation system 302, pressure regulator 304, dust filter 306, control system 308, and sensor system 310 may be disposed within the interior 312 or on the surface of the inlet and/or outlet doors 314, with the doors being removably disposed in the sorption box 316. When the inlet and/or outlet doors are removed from the sorption box, the sorption box may be thereafter operate as simply an additional pipe or vent section in a larger HVAC system.

The sorption box may be configured to connect adaptably to tubing, piping, vents, or other HVAC components. The sorption box may be built into new HVAC systems or retrofitted into existing systems. It may be screwed or nailed in, or otherwise locked into place. The inlet and/or outlet walls may feature mechanisms, such as latch or screw-fit components, to adapt to the HVAC components. The sorption box may be positioned such that it is substantially or at least partly inside a building with the outlet wall positioned outside the building. Alternatively, the sorption box may be located inside a room in which filtering and adsortion is desired, or behind the wall of such a room but with access thereto. In one variation, the sorption box is independent of other HVAC components but is instead a stand-alone machine. As shown in FIG. 4, the sorption system may feature sorption units 402, the sorption units capable of adsorbing or absorbing flammable and/or toxic gases. The sorption units may be pads or packs made of or filled with sorption material. The sorption material may also be provided in coils, particularly meshed coils, thereby increasing the surface area of sorption. The sorption material may substantially fill the sorption box cavity, or, In order to facilitate replacement, the sorption units may be placed in and removed from sorption chambers 404, which are disposed inside the cavity. The chambers may hold the sorption units in place while still permitting airflow thereupon. A chamber may consist at least in part of a cage 406, which would enable air to enter while preventing a sorption unit from falling out. The cage may consist of wire or bars arranged latitudinally, longitudinally, diagonally, or in any other appropriate pattern. The cage may also comprise a mesh or floating screen.

The chambers may feature hatches 408 which provide access to the sorption units from outside the sorption box, but are also capable of being closed in order to prevent access thereof. The hatches may be substantially continuous and in line with the passage walls 410, being hingedly or slidably attached and engaged to the stationary portion of the passage walls.

In one variation, the sorption chambers themselves may be removable from the sorption box. The chambers may be fitted into chamber openings 412 that are disposed in the passage walls of the sorption box. The chambers and chamber openings may be screw-fit, constructed so that the former fits tightly into the latter, or otherwise configured to prevent the chambers from falling out of the chamber openings due to gravity or other unintended forces without grossly impeding a user from removing them. The chambers themselves may be disposed on a track 414 disposed inside the cavity and slidably removable from the sorption box 416.

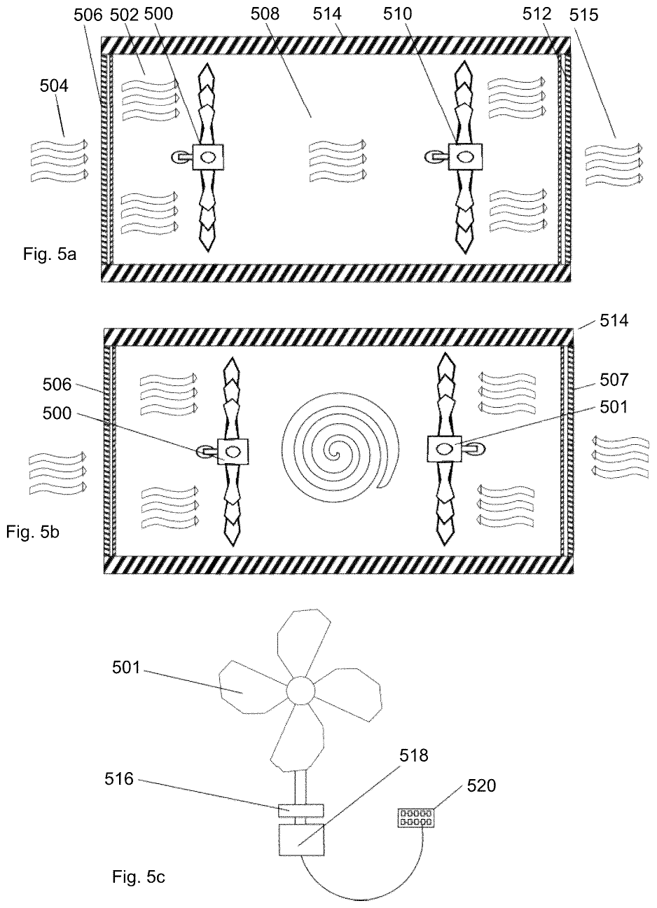

In one embodiment, the ventilation system may comprise an inlet fan and an outlet fan, with the inlet fan positioned close to the inlet wall and the outlet fan being positioned next to the outlet wall. The fans have a diameter approximating the sorption box diameter, so that all air entering the inlet wall may encounter and be handled by the inlet fan, and all air passing through the cavity may encounter and be handled by the outlet fan. As shown in FIG. 5A, the fans may be oriented so that the inlet fan 500 sucks in air 502 from the atmosphere 504 outside the inlet wall 506 and blows the air toward the cavity 508; conversely, the outlet fan 510 sucks in air from the cavity and blows the air toward and through the outlet wall 512 and out of the sorption box 515 However, in a preferred embodiment, as shown in FIG. 5B, the outlet fan operates as a second inlet fan, such that both fans suck air from the environment and blow air into the cavity. In this preferred embodiment, the sorption box 514 consists of a first and second inlet wall 506, 507 and a first and second inlet fan 500, 501, with the first inlet fan disposed behind the first inlet wall and the second inlet fan disposed behind the second inlet wall. In lieu of or in combination with the fans may be a ventillation assembly additionally comprising a compressor/blower and/or vacuum pump.

In the preferred embodiment described above, as shown in FIG. 5c, the second inlet fan may be disposed on a rotation mechanism 516, such as a rotating platform or a rotating axle, which enables the second inlet fan to rotate from a cavity-facing orientation to an atmosphere-facing orientation, thereby converting the sorption box from containment-type chamber to pass-through type. The rotating mechanism may be controlled manually by a user, such that the rotating mechanism may be physically rotated directly or indirectly by the user, or electrically. The rotating mechanism may be connected to a motor 518 which, when receiving a (wired or wireless) signal from the control system 520, a dedicated module, or a mobile device, will cause the rotating mechanism to rotate and thereby change the second inlet fan's orientation.

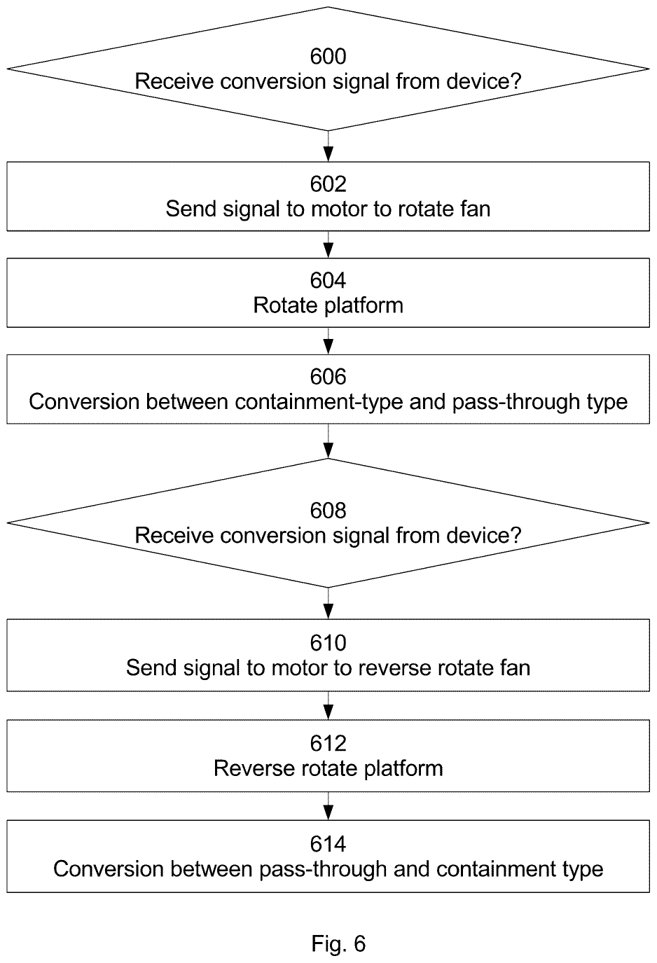

The conversion between containment-type and pass-through type, as shown in FIG. 6, may work as follows: The control system may receive a signal from a mobile device 600 to convert the containment-type chamber to a pass-through type chamber. The control system may send a signal to the motor to rotate the second inlet fan 602. The motor will then operate, causing the platform on which the second inlet fan resides to rotate 604. The inlet fan will then experience a full rotation (of approximately 180 degrees) 606, and conversion between the containment-type chamber and the pass-through type chamber will be achieved. If the control system receives a second signal from the mobile device 608 to convert the pass-through type chamber to a containment-type chamber, the control system will send a signal to the motor to reverse rotate the second inlet fan 610. The motor will then reverse rotate the second inlet fan 612 and the inlet fan will experience a full rotation 614, and conversion between the pass-through type chamber and the containment-type chamber will be achieved. Conversion may also be effected by reversing the spin direction of the fan(s).

The compressor may be disposed between the inlet fan and/or door and the cavity, and configured to reduce the volume of the gas in order to facilitate sorption by the sorption units. An additional or alternative compressor, optionally coupled to a vacuum pump, may be disposed at the outlet of the sorption chamber; this configuration enables the desorption, reuse, and replenishment of the sorption material.

The gas collection container may be rigid or made of inflatable material. It is preferably in fluid communication with the cavity, thereby leeching densified and contaminated air from the sorption box. This gas collection container may, in one variation, be intermediated by a ventilation fan in order to accelerate gas collection.

Transport of contaminated or cleaned air may be facilitated by a series of valves intermediating the various components of the device. For example, a first set of valves may control flow from the compressor to the cavity, a second set of valves may control flow from the cavity to the gas collection container, and a third set of valves may control flow from the cavity to outlet fans or to the outlet wall.

The dust filter is (dust filters are) preferably disposed within or behind the inlet wall(s). The dust filter is configured to catch particles smaller than 1 mm in diameter which the inlet wall(s) otherwise might not catch, such as dust particles, which are between 2.5 and 10 microns.

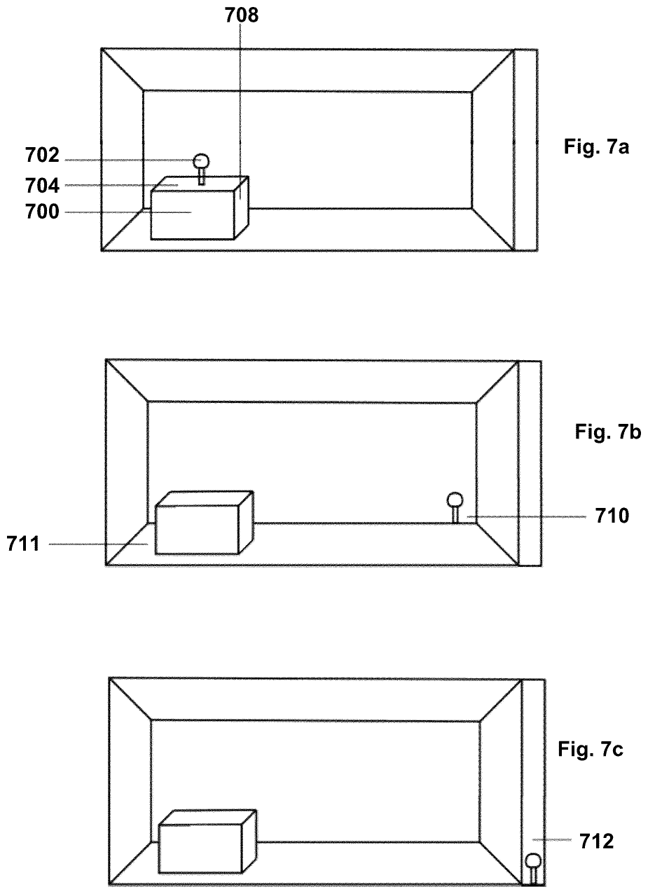

As shown in FIGS. 7A-C, the sensor system 702 may be positioned anywhere on the sorption box 700, such as the passage 704, inlet or outlet walls 708, or elsewhere, such as in one part of a room 710 while the sorption box is located in another part of the room 711 or even within a wall 712. If the sensor system is not physically attached to the sorption box, it may be connected via wires or engaged to to the control system via a wireless interface, such as bluetooth or WiFi.

The sensor system may include a gas sensor configured to detect flammable or toxic gases. Examples of gas sensors include metal oxide based gas sensor, optical gas sensor, electrochemical gas sensor, capacitance-based gas sensor, calorimetric gas sensor, or acoustic based gas sensor. The gas sensor may consist of sensing elements such as a gas sensing layer, a heater coil, an electrode line, a tubular ceramic, or an electrode. Examples of gases which may be sensed include methane, butane, LPG, smoke, alcohol, ethanol, CNG gas, natural gas, carbon monoxide, carbon dioxide, nitrogen oxides, chlorine, hydrogen gas, ozone, hydrogen sulfide, ammonia, benzene, toluene, propane, formaldehyde, and other various toxic or flammable gases.

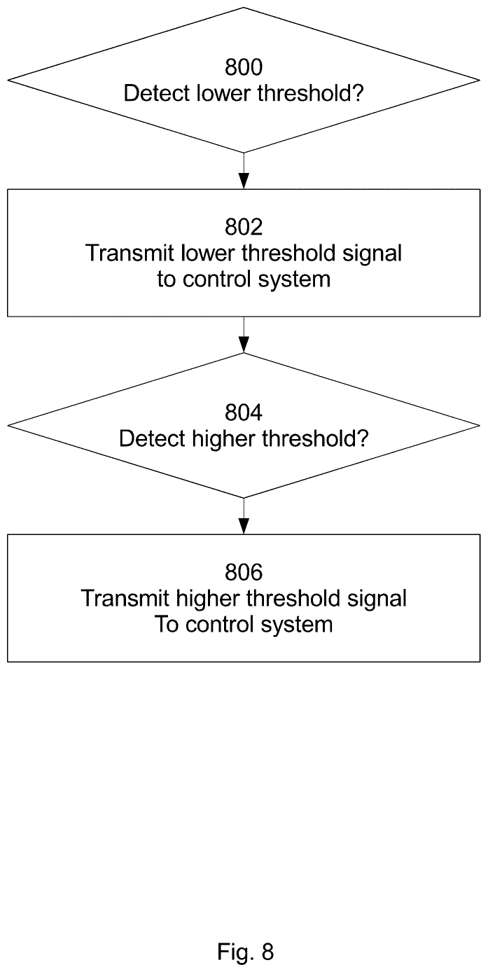

Upon detecting a designated concentration level of an undesirable gas, the sensor system is configured to transmit a gas detection signal to a wireless receiver inside the control system. The designated concentration levels of undesirable gases may be based on lower flammability limits or on recognized toxicity levels, which are levels where the gas becomes dangerous to human or animal health. In one variation, as shown in FIG. 8, there are two separate gas detection levels—a lower threshhold and an upper threshhold. In this variation, the sensor system transmits a lower threshhold gas detection signal to the wireless receiver 802 upon detecting a lower threshhold of gas 800, which is a level which it is considered advisable to human operators or users but which does not yet reach or approach the lower flammability limits or recognized toxicity levels, and transmits an upper threshhold 806 gas detection signal upon detecting an upper threshhold of gas 804.

The sensor system may be configured to detect the concentration of a given gas, approximate that concentration numerically, and transmit the numerical concentration to the control system or directly to a visual display to enable users or operators to view and track the gas levels. The concentration levels may be captured and transmitted in real time, or captured at reoccurring intervals, such as once an hour, once a day, or once a week. The captured concentration levels may be saved in a database for future reference. In one variation, the concentration levels are transmitted to a dedicated module or mobile device, where they are converted into trending data, and the trending data may be saved on the module or device and displayed upon request by the user.

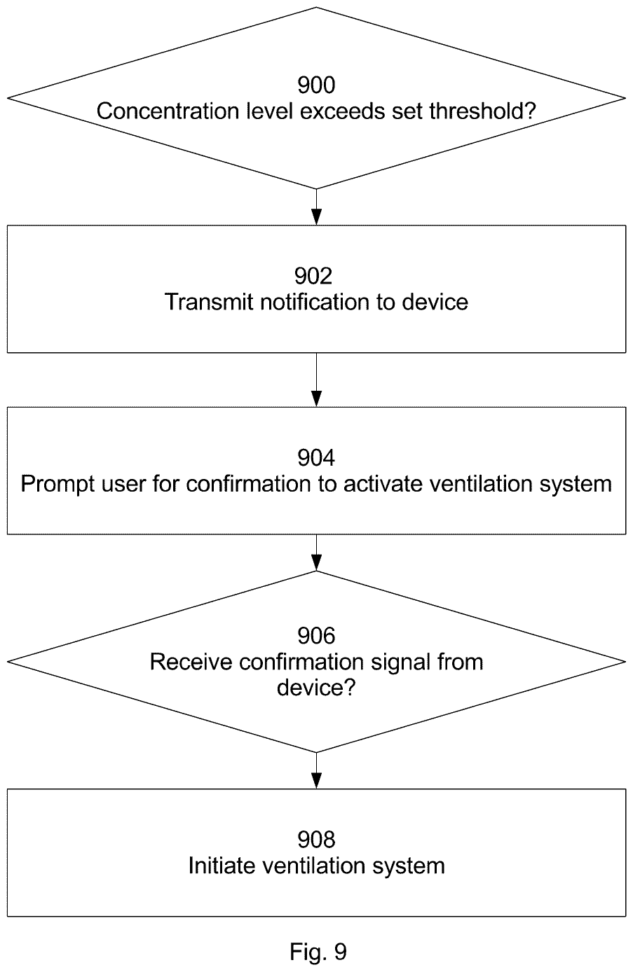

As shown in FIG. 9, upon capturing a concentration level that equals or exceeds a set threshhold 900, the sensor system may transmit a notification wirelessly to the user's mobile device or a dedicated module 902, informing the user of the concentration level or that the concentration level has exceeded the set threshhold, and then prompt the user for confirmation to activate the ventilation system 904. In one version, the ventilation system is automatically activated without requiring user confirmation.

The control system comprises a set of processors and wireless receivers disposed within a container. Upon receiving the wireless detection signal from the mobile device 906, the control system is configured to initiate or permit an electric flow to the ventilation system 908, thereby turning on the fans. In the variation described above, the control system may permit electric flow to the ventilation system upon receiving an upper threshhold gas detection signal, but only turn on a warning signal upon receiving a lower threshhold gas detection signal. The warning signal may be a light, such as a bulb, LED, or other illumination component, configured to illuminate in either a steady stream or flashing pattern, and which is signalled electrically or wirelessly by the control system. The warning signal may be a text message or other notification sent to a human user or operator's phone or a separate display screen. The warning signal may also be an audio transmission, such as a beeping sound, emitted from a speaker disposed on or in the sorption box or else positioned in the targeted room and wirelessly connected to the control system. An exemplary manifestation of the control system may be a SCADA (supervisory control and data acquisition) system, which includes software and hardware elements enabling the control of processes locally or remotely, the monitoring, gathering, and processing of real-time data, interaction with devices such as sensors, valves, pumps, and motors though a human-machine interface, and the recording of events into a log file.

In one variation, the user may communicate with the control system and/or sensor system using the dedicated module or mobile device via a dedicated user interface. The user may observe the concentration levels in real time and observe historical concentration data. The user may send a signal to the control system to turn on the ventilation system based on target concentration levels, which may be set by the user using the user interface, and/or manually.

The control system and/or the ventilation system may be mechanically, hydraulically, or battery operated, feature a plug for inserting into an electrical outlet, and/or hardwired into a building's electrical wiring. If the control system is battery operated, the battery may be contained in a battery box, with the battery box being disposed inside or adjacent to the control system. The battery box may be positioned so that it is accessible from outside the sorption box so that the battery may be easily removed and replaced. The battery box may feature a port which passes through the walls of the sorption box and configured to receive a battery charger.

The control system may impose various activity programs on the components of the device, principally by controlling the electrical flow to the one or more fans and the one or more motors, thereby turning the one or more fans on or off, increasing or decreasing rotations speeds of the one or more fans, or switching the directional orientation between the outlet orientation and the inlet orientation. The control system may also control the valves that permit or block fluid flow from entering the device, moving throughout the device, (such as between the compressor and the cavity, the cavity and the gas collection container, the cavity and the outlet fans), and exiting the device. The doors comprise a row of shutters, such that when the shutters are oriented perpendicular to a door, the door is in an open state, and when the shutters are oriented substantially in line with the door, the door is in a closed state. The shutters may be electrically and mechanically controlled by the control system as well. The control system may additionally control vacuum pumps, blowers, compressors, and any and all other electrical parts forming the ventilation system.

In certain embodiments, the control system operates according to alternating adsorption programs in which two or more sorption modules are selectively engaged in sequence. For example, during a first program a contaminated gas stream may be directed into a first sorption module while a second sorption module is isolated or undergoing regeneration. When the control system determines that gas concentration in the ambient environment ceases to decrease, or when saturation of the first sorption module is detected, the system may transition to a second program in which the gas stream is redirected to the second sorption module while the first module undergoes regeneration or standby. Such alternating operation enables continuous remediation of gas leaks while extending sorbent lifetime.

In certain embodiments, gases released from sorption materials during regeneration or desorption cycles may be directed to a collection container coupled to the sorption modules through controllable valves. The collection container may retain the separated gas species under pressure until they are intentionally released or disposed of. Pressure sensors, valves, and pressure regulators may be used to control the transfer and storage of such desorbed gases.

In one program, the control system determines if the sorption units have reached capacity based on the internal contaminant gas signals, and if so, imposes a containment program on the ventilation system, with the containment program featuring either all of the one or more fans turned off or turned on and put into the inlet orientation. The containment program may be subceeded by a collection program, in which the valves connecting the cavity to the gas collection containers are opened for a span of time, ideally until the gas collection containers are filled to capacity, hereafter the valves are shut off. To assist in determining whether the gas collection containers are filled to capacity, a pressure sensor in signal communication with the control system may be disposed between the valve and the gas collection container. This gas collection container may be removably attached to the cavity such that once it is removed, it may be sealed up. In one variation, the valve is principally attached to the gas collection container and is removed with it. In another variation, the valve is principally attached to the cavity, and the gas collection container must be sealed by other means, such as via a cap or a separate valve.

In another program, the control system determines if the contaminant gas levels in the atmosphere are too high (although this may also be the default assumption for the control system, and therefore a default program). If so, the control system imposes a concentration program on the ventilation system, with the concentration program set for increasing the speed of the one or more fans in an inlet orientation or switching one or more fans from an outlet orientation to an inlet orientation.

In yet another program, the control system determines if the sorption box pressure is too high, and if so, imposes a pass-through program on the ventilation system, with the pass-through program featuring at least one fan in an outlet orientation, cessation of compressors/blowers at the inlet, an adjustment of needle valves/pressure valves throughout the system.

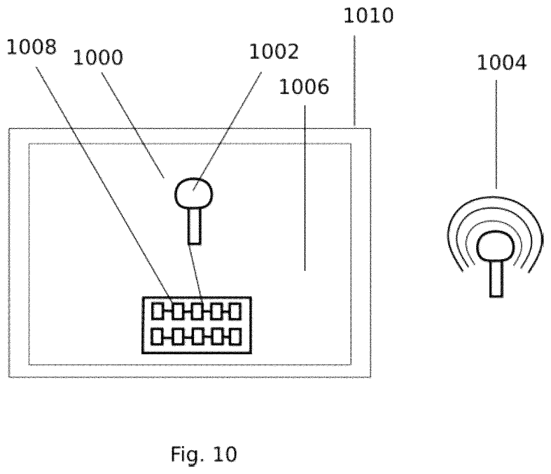

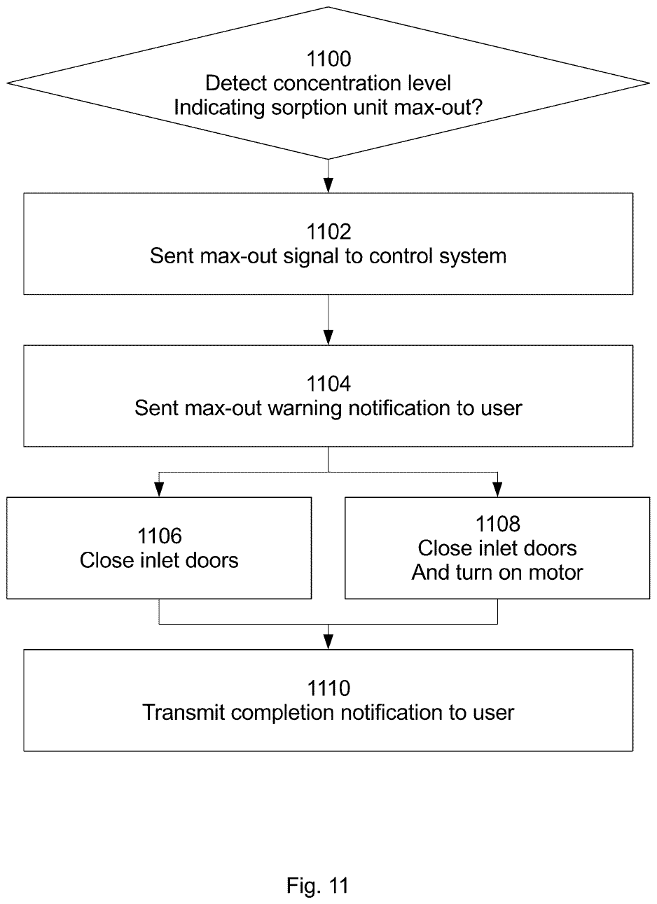

In one variation, as shown in FIG. 10, the sensory system 1000 comprises a first 1002 and second sensory set 1004, with the first sensory set being positioned inside the cavity 1006 and being electrically connected to the control system 1008 and the second sensory set being positions outside the sorption box 1010, perhaps several to many feet away, and connected to the control system using a wireless protocol. This first sensory set may also be in wireless communication with the user's mobile device or dedicated module, and may inform the user when the concentration level of gas in the sorption box is such that the sorption units may have reached their sorption limits, thereby informing the user that the sorption units may need to be checked or replaced. This information may also influence the user, and additional information may be sent suggesting, to close the inlet (and outlet doors), to thereby keep the gas from escaping the sorption box and thereafter turn off the ventilation system, or to rotate the second inlet fan into an outlet fan in order to blow the gas out of the sorption box and into collection bags or an atmosphere outside the building (or into a collecting pipe or apparatus). These steps may also be automated according to the following processes, as shown in FIG. 11: 1. The second sensory set detects a concentration level which indicates that the sorption capacity of the sorption units have maxed out 1100. 2. The control system receives this signal 1102, and then wirelessly transmits a notification to the user 1104. 3a. The control system may trigger the inlet doors to close, and thereby prevent the gas from deadsorbing or deabsorbing and exiting the sorption box 1106, or 3b. The control system may trigger the first inlet door to close and trigger the motor connected to the second inlet fan to rotate into an outlet fan and blow the lingering gases into a collection bag, pipe, or apparatus or into the atmosphere 1108. 4. Transmit a process completion signal to the user 1110. As an additional or alternate step to any of the above, the control system may trigger the inlet valves to close so that the vacuum pump can remove the air trapped within the sorbtion material, thereby conditioning the sorption material for reuse. The control system may trigger valves disposed between the vacuum pump and the outlet to open, thereby enabling the vacuum pump to suck the gas out.

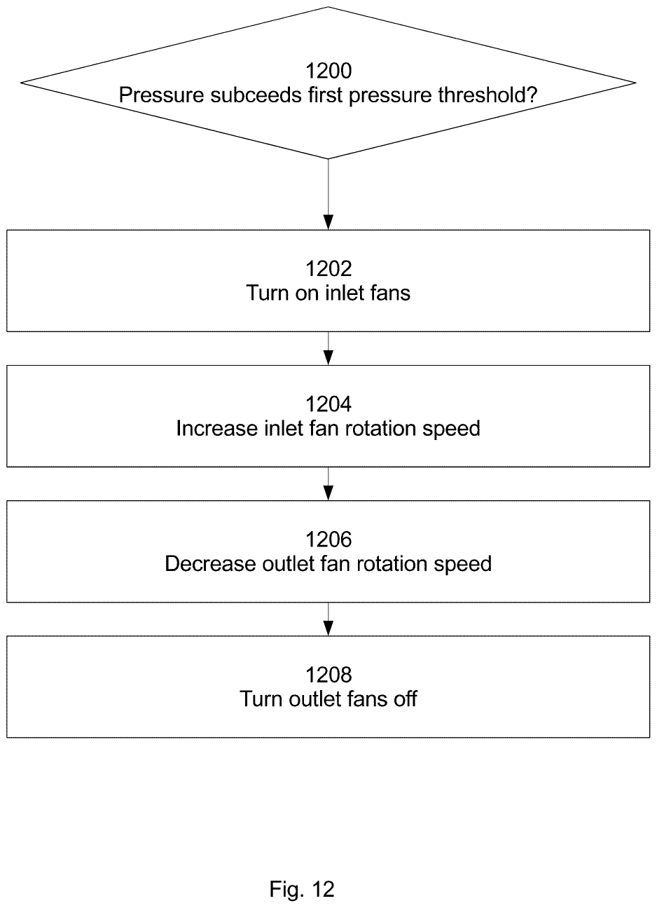

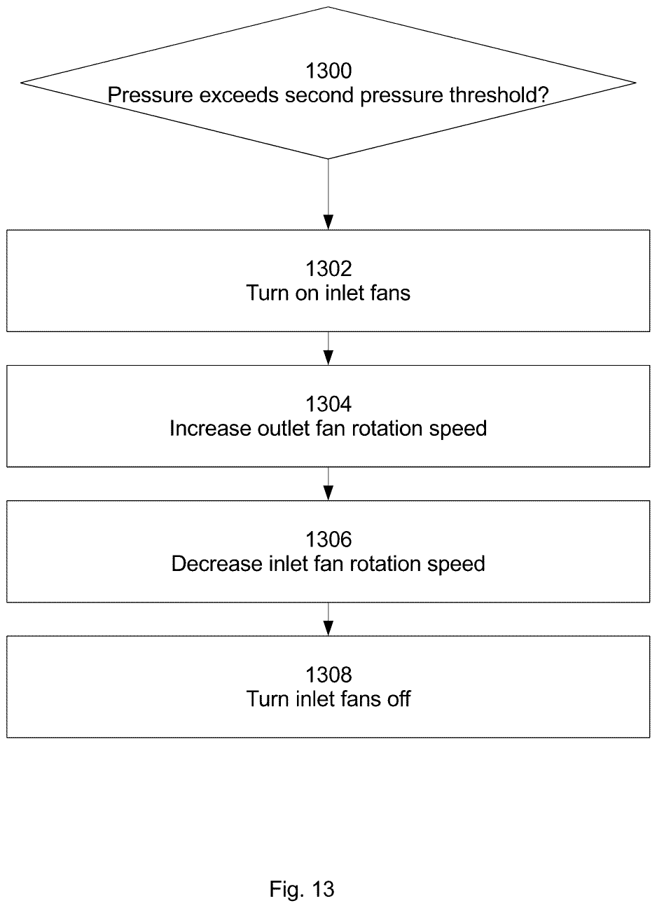

The pressure regulator features a pressure sensor designed to detect the measurement of gas pressure. Based on the degree of pressure imposed on the sensor, the pressure regulator generates an electrical signal to convey the pressure measurement to other components. As shown in FIG. 12, while the pressure subceeds a first pressure threshhold 1200, the pressure regulator may communicate with the ventilation system to turn the input fan(s), compressors/blowers, and vacuum pumps on 1202, permit or instruct the input fan(s) to increase their rotation speed 1204, turn the output fan(s) off 1206, and/or permit or instruct the output fan(s) to decrease their rotation speed 1208, thereby increasing the density of air, and thus the pressure, in the adosorption box. Conversely, as shown in FIG. 13, when the pressure exceeds a second pressure threshhold 1300, the pressure regulator may communicate with the ventilation system to turn the output fan(s) on 1302, permit or instruct the output fan(s) to increase their rotation speed 1304, turn the input fan(s) off 1306, and/or permit or instruct the input fan(s) to decrease their rotation speed 1308, thereby decreaseing the density of air, and thus the pressure, in the adosorption box.

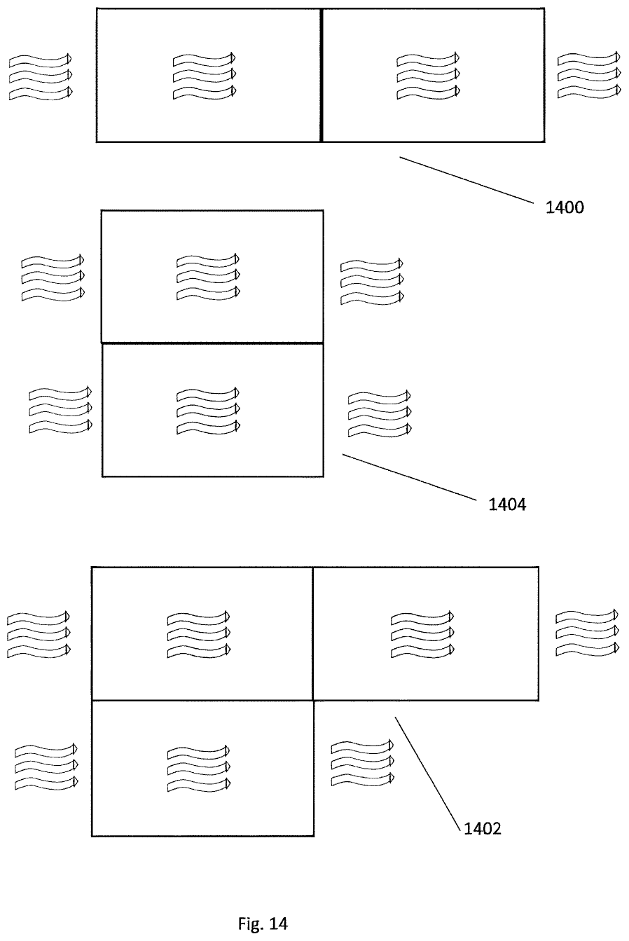

As shown in FIG. 14, a plurality of sorption boxes may be positioned in a series 1400, such that once the sorption capacity of the sorption units of a first sorption box are maxed out, the first sorption box may blow its gas-heavy air into the second sorption box, and so on. A plurality of sorption boxes may simultaneously 1402 or alternately 1404 be positioned in parallel, such that each sorption box has an inlet adjacent to the atmosphere and not to the outlet of any other sorption box. Each sorption box may be dedicated to capturing a different type or category of gas; for example, a first set of sorption boxes may be dedicated and configured to capturing flammable gases while a second set of sorption boxes may be dedicated and configured to capturing toxic gases. Each sorption box of the first set may be dedicated to a subset of flammable gases and each sorption box of the second set may be dedicated to a subset of toxic gases.

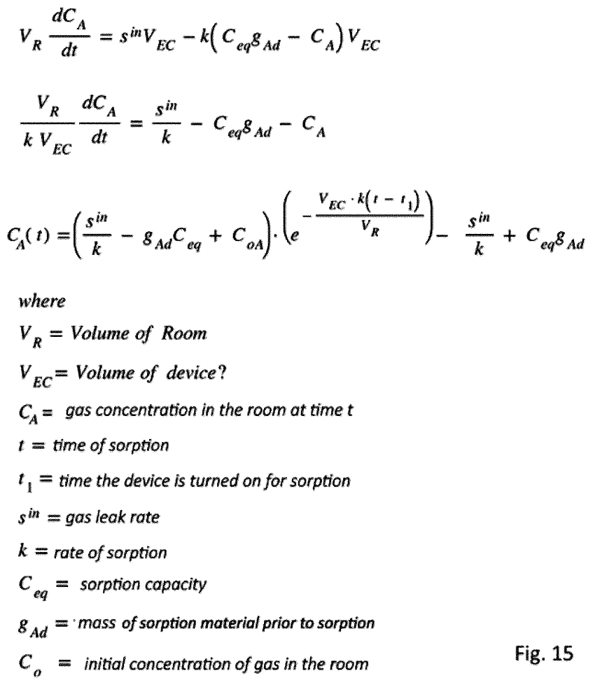

The sorption box may be sized proportional to the space in which filtering and gas sorption is sought, and may be calculated according to the equations shown in FIG. 15.

Additional examples of sorbents include catalytic sorbents, photocatalysts, polymerics, MOFS, Alkali metals such as carbonates and oxides, amine solid sorbents, carbonaceous materials such as carbon nanotubes and carbon molecular sieves, zeolites, mesoporous silica, alumina, hydrotalcite-like compounds (HTICs), metal-based oxides such as CaO based sorbents, porous MgO, Sodium Zirconate, Lithium compounds, and Na₂O promoted alumina, activated carbons, sorbents. So-called photocatalysts, such as titanium dioxide, work to disinfect by, upon being disposed to light, generate hydroxyl radicals.

In one embodiment, one or more sorbents and/or the sorption box are coated with crystalline coating material, which is configured to generated hydroxyl radicals upon being exposed to light. Hydroxyl radicals are observed to denature viruses, such as SARS-Coronavirus, by damaging viral exterior features, such as the crown or spike proteins, puncturing the lipid membrane, and exposing the RNA contents. The crystalline coating material may include metal organic frameworks (MOF), which operate as desiccants by providing an enlarged, porous, surface area with external-facing molecules in a cage-like structure that are likely to bind and thereby capture free-floating molecules. The crystalline coating material may be added to traditional sorbents as an applied layer or may be used as sorbents by themselves. The use of crystalline coating material in conjunction with other sorbents and/or the sorption box may also provide disinfecting effects on bacterial and fungal growth. In another embodiment, the sorption box is coupled with an Ultra Violet (UV) emitting bulb or light source. The use of UV is an effective method of denaturing viruses, and acts to damage the exterior features of the virus, thereby exposing and further damaging the RNA contents. As shown in FIG. 18, the UV light source 1800 may be connected electrically and informationally to the sorption box control system 1801 of the sorption box 1802 in order to enable automatic or manual control over the duration, intensity, and wavelength of the UV light. The control system may set the UV light settings based on feedback from the sensor system 1804, which may detect the number of individuals inside a room 1806 using infrared sensors 1808, and whether individuals sneeze or cough using microphones or other sound sensors. In a more advanced feature, the sensor system includes a swab arm that mechanically ushers potential viral matter that has settled on a surface interior or exterior to the sorption box, depending on the sensor setup, into a miniaturized PCR (polymerase chain reaction) or LFT (lateral flow test) testing system, which may include a thermocycler, immunoassay technology using nitrocellulose membranes, colored nanoparticles or labels, and antibodies. After running a PCR or LFT test, the control system can be informed whether viral matter is present, as well as the specific type of viral matter, and run the UV light parameters according to the specific parameters determined to most capably destroy the viral matter.

In one embodiment, the sorption box features a heating mechanism, such as conventional heating elements found in portable heaters, and which are electrically connected to the control system. The control system may provide for manual control over heating, automatic control based on feedback provided by thermometrical sensors, or a combination of the two, such that a user can program the heating elements to activate upon the detection of a lower threshold temperature and deactivate upon the detection of a higher threshold temperature. The user may also program the control system to activate the heating elements based on sorbent activation or dehydration requirements. The heating system may also be used for humidity control in order to maintain the efficacy of the sorption units. Dehumidification may be scheduled or programmed to occur upon the detection of a set humidity threshold. Finally, the control system may be configured to apply a desorption program upon detecting an adsorption saturation point has been reached or based on a schedule.

In one embodiment, the sorption units may feature a multi-sorbent complex, featuring multiple layers stacked together, with each layer comprising a different material, thickness, density, or configuration of sorbents. The layers may be stacked in a pile, or radially such that a first layer comprises a core which is then surrounded nearly entirely by a second layer, and so on.

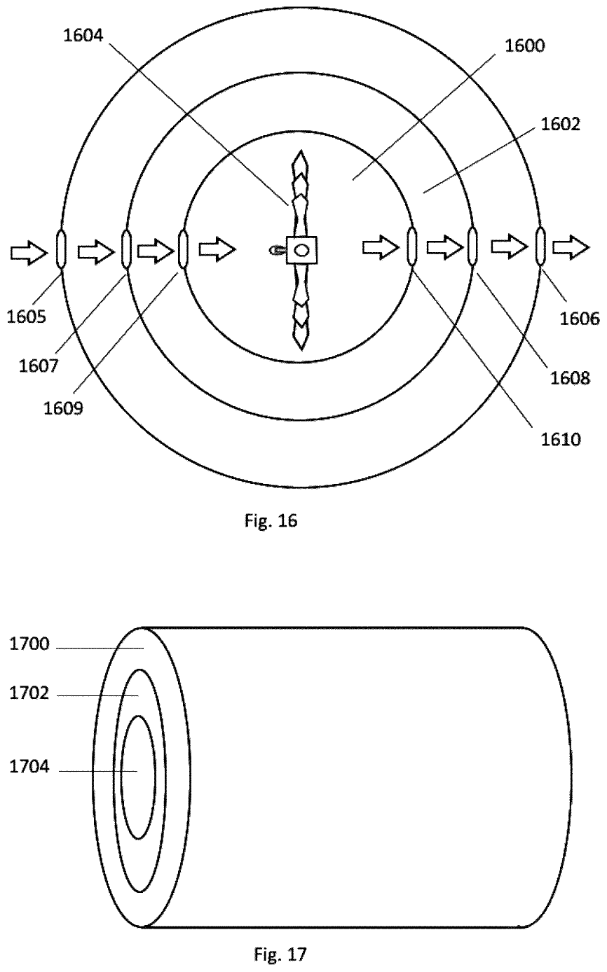

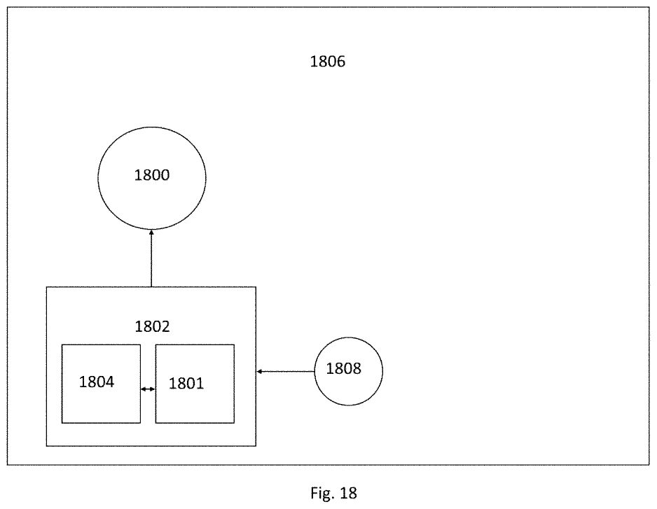

In another embodiment as shown in FIG. 16-17, the sorption boxes may be shaped cylindrically and sized so that one sorption box 1600 may be placed internally to a second sorption box 1602 as an internal cylindrical layer. Each sorption box may have its own dedicated ventilation system so that the sorption boxes may be separated and used independently. In one variation, they may share the mechanical aspects of a single ventilation system 1604 placed in a “core” or inner-most layer and/or the outer-most layer. The ingresses 1605, 1607, 1609 and egresses 1606, 1608, 1610 of the sorption boxes may line up so as to enable the atmosphere to flow through (and be sucked in via the ventilation system) the outer-most layer to the inner-most layer. The sorption boxes may utilize separate and decicated valves, piping, compresors/blowers, and vacuum pumps at each egress, or may share a common set at the final egress. As shown in FIG. 17, the ingresses 1700, 1701, 1703 and egresses (not shown) may also be disposed on the exposed face of all layers so that ingress and egress of atmospheric air may occur directly through each layer without having to first pass through a separate layer. As mentioned previously, each sorption unit may be dedicated to a specific type of gas control and may be activated independently based on the detection of its target gas/contaminant (i.e., dust, pollen, smoke, viral particle, toxic gas, flammable gas, etc.). Thus, a first sorption unit may target toxic gases, a second sorption unit may target combustible gases, a third sorption unit may target viral, bacterial, or fungal particles, and a fourth sorption unit may target air purification.

As previously discussed, the control system may transmit a communication to a user's mobile device or to a dedicated device conveying sorption system activity, including instructions to replace one or more sorption units. The control system may also be configured to transmit communications to third parties such as fire departments. The transmission may be wirelessly via Bluetooth, WiFi, or some other wireless protocol. In one embodiment, each sorption box and/or sorption unit is equipped with a scale or other weight measuring mechanism to determine when the sorption unit has reached its saturation point. The system may also make this determination based on measurements of inlet flowrate, concentration, and/or operation/remediation time. The system may also include a user interface configured to inform the user as to the location of sorption unit disposal or recycling services. Such information may be displayed as pins on a map. The system may either itself comprise or be coupled to a GPS application.

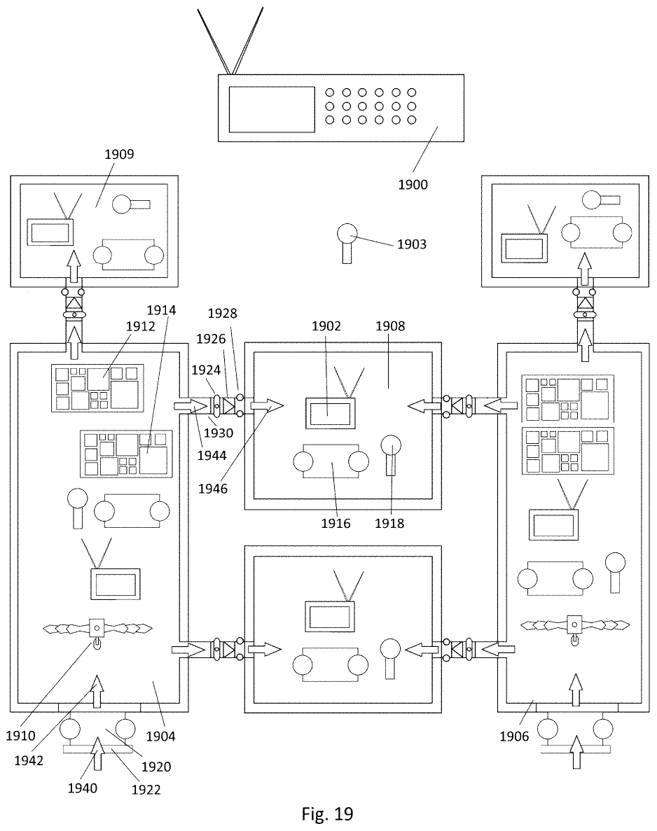

In one embodiment, as shown in FIG. 19, the sorption boxes 1904, 1906 are arranged in parallel, such that each of the sorption boxes are in fluid communication with the ambient air, particularly enabling air flow from the ambient air into the sorption boxes. The sorption boxes are principally configured to absorb or adsorb flammable and/or toxic gases, and as such, contain various sorption units, including gas sorbents 1912 and humidity sorbents 1914, the latter of which permits more efficient use of the capacity of the gas sorbents. A humidity filter 1922 may also be fitted at the sorption box inlets to decrease the humidity entering in the first instance. Finally, the sorption boxes may be equipped with ventilation systems 1910 in order to impel air inward.

The boxes are each in turn in fluid communication with one or more shared collection containers 1908, and one or more dedicated collection containers 1909, via pipe or tube outlets 1930 fitted with a series of outlet valves 1924, outlet pumps 1926, and outlet compressors 1928. Resident compressors 1916, positioned not at the outlets but within the sorption boxes and collection containers themselves, may be used to further increase the volumetric efficiency of the system. Inlet compressors 1920, positioned at the inlet of the pass-through walls of the sorption boxes, may also be used to compress the air before it enters the sorption boxes. The outlet, resident, and inlet compressors are optional, and each or all may be omitted depending on the properties of the target gas.

Air flow 1940 entering a sorption box may be substantially identical to ambient air. The air flow may pass through a humidity filter, such as a desiccant layer, in order to decrease the air flow's moisture content. The air may pass through a compressor to reduce the air flow volume as it enters the sorption box. These measures will have the effect of reducing the pressure and increasing the concentration of the undesirable gas in the air flow 1942, which will assist the sorption process of the sorption units.

Air flow 1944 entering the piping between the sorption box and the collection container may be substantially concentrated with the undesirable gases previously captured by the sorption units. During the desorption process, the outlet valve is opened, and the outlet (vacuum) pump and outlet compressor may be engaged, thereby reducing the air pressure and impelling the air flow, diverting the oxygen, nitrogen, carbon dioxide, previously trapped gas and air, etc., in the atmospheric air, from the air flow, and compressing the air flow 1946 as it enters the collection container.

By collecting and at least partially emptying the gas from the sorption boxes, the sorption boxes are able to regain their sorption capacity and continue remediating the ambient air. There may be two or more sorption boxes, and each sorption box may be preceded in a series (or in parallel) by a sorption box of a different function, such that each sorption box in a series (or in parallel) is dedicated to resolve a certain category of air quality problem, such as eliminating combustible air, toxic air, and/or infected air. The sorption boxes connect and convey fluid to the collection container via a configuration of (vacuum) pumps, valves, pipes, flow meters, tubes, fittings, and adapters. Control of the pumps, valves, etc., is obtained via an electrical and mechanical control system 1900. The control system may, upon receiving pressure, concentration, time, flow rate, weight change, gas type, temperature, humidity, sorption type, sorption material capacity and kinetics, compressor activity, pump activity, ventilation system activity, and other feedback parameters from various sensors indicating that the sorption box, collection container, or ambient air has reached a parameter threshold, engage the valves to open, engage the pump to pump air into the collection container, engage the compressor to reduce the air volume entering the collection container, etc.. The control system may be in wired or wireless informational communication with an ambient sensor 1903, with the ambient sensor being disposed outside any given sorption box or collection container, and configured to capture data corresponding to the ambient air. The control system may calculate or predict, in advance, the occurrence and time of occurrence of various events, such as parameter thresholds, or the time required for various events, such as sorption or desorption, based on the various feedback parameters.

The controller may utilize SCADA (supervisory control and data acquisition) software.

In one variation, the control system is configured to receive weight measurements of the sorption boxes transmitted by weight sensors, and permit and facilitate fluid flow from the sorption box to the container when the weight measurement of the sorption box exceeds a designated threshold. The weight sensors may comprise a scale disposed below a given sorption box.

The control system may comprise a single central controller/control system, or a combination of a central master control controller (or system) and a series of local control controllers (or systems), with each sorption box and collection container having its own local control system 1902. Each local control system may be configured to electrically and mechanically control the local valves, pumps, compressors, ventilation systems, etc., and be in informational communication with the local sensors 1918. With a local component being a component being disposed inside or at an inlet or outlet of a sorption box or collection container to which the local control system is dedicated. Each local control system in turn may be in electrical and/or informational communication with the central master control system. Informational communication may occur through any wired or wireless protocol. In one variation, each collection container is in dedication connection to a single sorption box. In another variation, collection containers may be shared between sorption boxes. In this variation, the control system may engage the pumps, valves, etc., to prevent fluid from flowing from a first sorption box, into the collection container, and then into a second sorption box. This will prevent the duplicative process of the second sorption box being required to convey the fluid flow back into the collection container. This shared-container configuration has the advantage of a continual, uninterrupted sorption process-at least one of the sorption boxes can perform a sorption process while at least one other sorption box desorps its previously sorped gas into the collection container. In yet another variation, each sorption box is engaged with a plurality of collection containers. In yet another variation, each sorption box is engaged with a plurality of collection containers, but these collection containers are also shared with other sorption boxes.

In one embodiment, the collection container is engaged with a compressor. In one variation, the compressor may be disposed between the sorption box and the collection container, in order to compress the air received from the sorption box before conveying it into the collection container. In another variation, the compressor is disposed within the collection container and is configured to compress the air within the collection container. The compressor may be electrically and informationally engaged with the control system, which is configured to determine and set the compression power/flow rate based on various sensor-derived parameters. These sensor-derived parameters may be continually or intermittently entered into an equation to determine the most electrically and/or mechanically efficient and/or expedient compressor power/rate based on the detected or expected gas sorption and conveyance. These parameters may include, as mentioned, the fluid pressure detected within the compressor, the fluid pressure detected in the collection container, the pressure detecting at the piping and/or valves, the weight change of the sorption box, the weight change of the collection container, the category of gas detected in the sorption box, the flow rate detected between the ambient air and the sorption box, the flow rate detected between the sorption box and the collection container, and the inflation/deflation measurements of the collection container itself. If the collection container is shared between sorption boxes, then the parameters may also pertain to the other sorption boxes as well. If multiple collection containers are engaged to a given sorption box, then the parameters of each collection container is used to determine the compressor rate/power for the other collection containers.

In one variation, the compressor and/or pump may be positioned at the pass-through walls of the sorption box or in the sorption box, so that the ambient air may be compressed and impelled prior to being conveyed into the collection container.

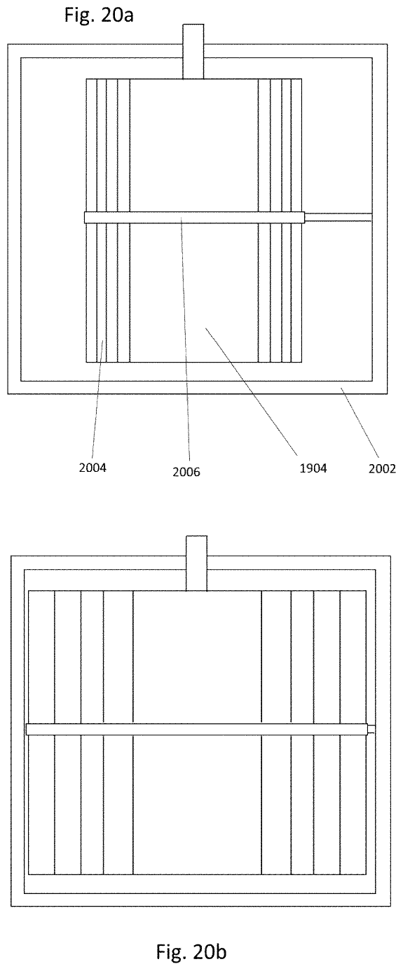

In one variation, the collection containers are fixed in their material dimensions. In another variation, the collection containers are made of flexible and/or expandable materials to enable deflation when not in use and gradual inflation during use. In a third variation, as shown in FIG. 20a-20b, the collection 1906 container is made primarily of a flexible material, and is disposed in a rigid shell 2002 - once the dimensions reach those of the rigid shell, the collection container would not be expanded further.

In one embodiment, as shown in FIG. 20, the collection containers operate like diaphragms—that is, they passively expand or contract based on their internal pressure as gas is received and compressed. In an additional embodiment non-exclusive to the prior embodiment, the body of the collection containers are mechanically expanded. Mechanical expansion enables the collection container to undergo a pressure drop, thereby enabling more effective inward fluid flow as well as increased storage capacity. The mechanical expansion may occur via a series of flaps 2004 or accordion pleats which are kept flat via a mechanical ring or belt 2006. As the ring or belt is loosened, the flaps are free to open; if the flaps are attached to the ring or belt, then as the latter is mechanically opened, so too do the flaps. The ring or belt may be controlled by a pulley/wheel system, with mechanical control over a wheel upon which the belt is wound determining the length of the belt. If the belt is not attached to but merely surrounding the collection container, then the collection container expands as the amount of air contained therein increases. If the belt is attached at various points to the pleats, then as the wheel is mechanically rotated, the belt will drag the pleats further from the center of the collection container, thereby physically and actively expanding them. Mechanical control over the belt may be exercised by the control system.

In one embodiment, the control system comprises GPS technology for detecting the location of the system, if the control system is in proximity to the sorption boxes, or otherwise the sorption boxes, and in particular, the collection containers. When a collection container is detected at being at maximum capacity, which may include being in a condition of a maximum inflation, a maximum concentration, and as having maxed out all compression capacity, then the control system may, first, close all valves and conveyances out of the sorption boxes and/or into the collection containers, and second, relay a max capacity signal to a pertinent third party, such as a fire department, property manager, or dedicated waste removal organization. The third party will then be on notice to collect and replace the collection containers. In one variation, the control system sends a signal to the pertinent third party prior to the collection container being at maximum capacity, with the time difference associated with the time required for the third party to arrive at the premises to collection the collection container. The signal may be directed to a database or individual(s), and sent via an email, messaging application, or system notification/update.

In one embodiment, the control system is configured to detect a given (high) concentration of an undesirable gas in a room or closed area. When that given concentration is detected, the system sends instructions to a ventilation system, which may comprise fans and/or pumps, to begin conveying air into one or more sorption boxes. If the air remediation system detects that a given (low) concentration of the undesirable gas, the system sends instructions to the ventilation system to cease the conveyance of air into the one or more sorption boxes.

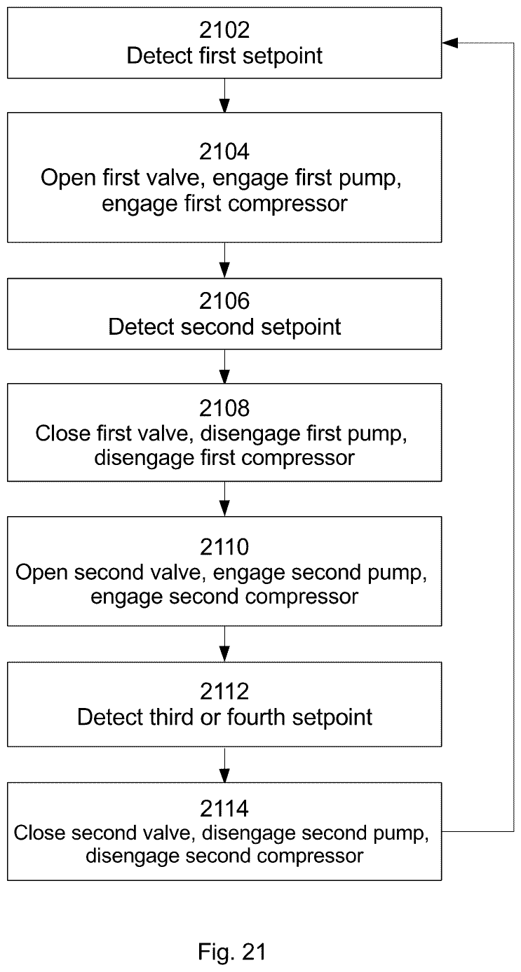

As shown in FIG. 21, the presently described event may be configured to operate an “Alternation Program”. The control system may detect a first setpoint 2102, which requires that a first sorption box needs to be desorbed of its gas into the collection container. This first setpoint maybe a first sensor detecting that the first sorption units have reached their capacity based on a direct measurement such as concentration level or an indirect measurement such as the weight of the sorption unit (or the sorption box as a whole). Alternatively, the first setpoint may be the lapsing of a given period of time since the sorption box began its sorption process. The control system may then open the first valve, engage the first pump, and engage the first compressor 2104 in order to enable airflow from the first sorption box into the collection container, decrease the pressure of the gas to impel the airflow, and then concentrate the gas in order to increase the volumetric efficiency of the collection container. The control system may then detect a second setpoint 2106, which requires that the second sorption box needs to be desorbed of its gas into the collection container, or that the first sorption box is sufficiently desorbed in order to being sorbing gas from the ambient air. This second setpoint may be any of the exemplary setpoints designated for the first setpoint, except here they are directed toward the second sorption box. The second setpoint may also be the first sensor detecting that the first sorption units have refreshed their capacity. The control system may then close the first valve, disengage the first pump, and disengage the first compressor 2108, and then open the second valve, engage the second pump, and engage the second compressor 2110. The control system may detect a third setpoint 2112, which requires that the first sorption box needs to be desorbed of its gas into the collection container, or that the second sorption box is sufficiently desorbed in order to being sorbing gas from the ambient air. This setpoint may again be any of the exemplary setpoints designated for the first setpoint, or that the second sorption units have refreshed their capacity. The system may then close the first valve, disengage the first pump, and disengage the first compressor 2114. The process may then repeat from the first step. The sorption boxes may share a compressor, vacuum pump, piping, and valves in common.

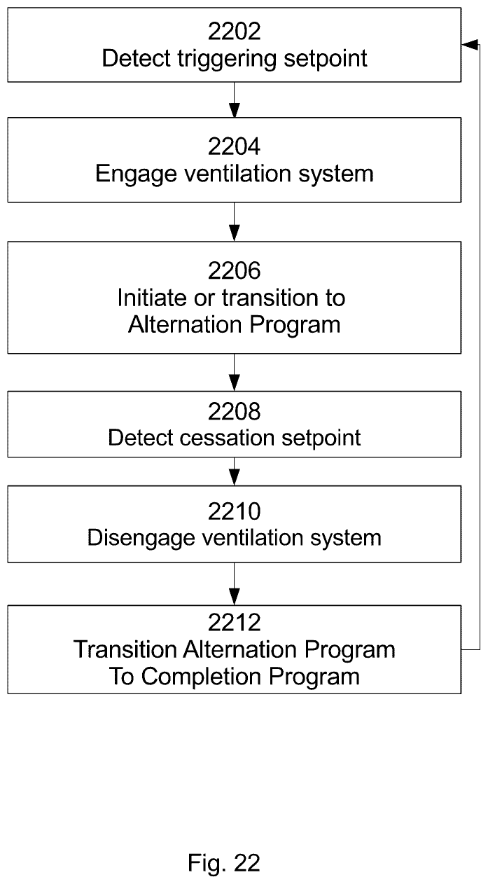

As shown in FIG. 22, the presently described device may be configured to operate a “Basic Program”. The control system may detect an initial setpoint via an ambient air sensor 2202. This sensor is configured to detect the concentration of a given target gas in the ambient air. The initial setpoint corresponds to a concentration of the target gas beyond which the operators of the device do not wish the concentration to exceed, and therefore triggers the Basic Program. The control system then engages a ventilation system of the first and/or second sorption box 2204. This engagement may occur directly, or via an intermediary of a local control system. The ventilation system may include any component or operation that enables or impels airflow into a sorption box. The control system may then initiate (or transition back into) the Alternation Program previously described 2206. The control system may then detect a cessation setpoint via the ambient air sensor 2208. The cessation setpoint corresponds to a concentration of the target gas of which the operators do not require further decrease. The control system may then disengage the ventilation system 2210 and transition the Alternation Program into a Completion Program 2212, in which the desorbing sorption box continues desorbing into the collection container until adequate desorption or refreshment of the sorption capacity is achieved, but the previously absorbing sorption box ceases absorbing from the ambient air. The process may then repeat from the first step. The ventilation system may also be disengaged, briefly, if the control system detects that the sorption boxes are at full capacity and require desorption. Alternatively, the Alternation Program may control the ventilation system by disengaging it when a sorption box is desorbing.

An “Emergency Program” may interrupt the Basic Program. The Emergency Program may be initiated if concentration of a flammable gas approaches combustion—in this case, the present device, which has electrical and/or mechanical components, could itself initiate the combustion thereof, and therefore, the Emergency Program sends a warning signal to a designated third party and then shuts down the present device.

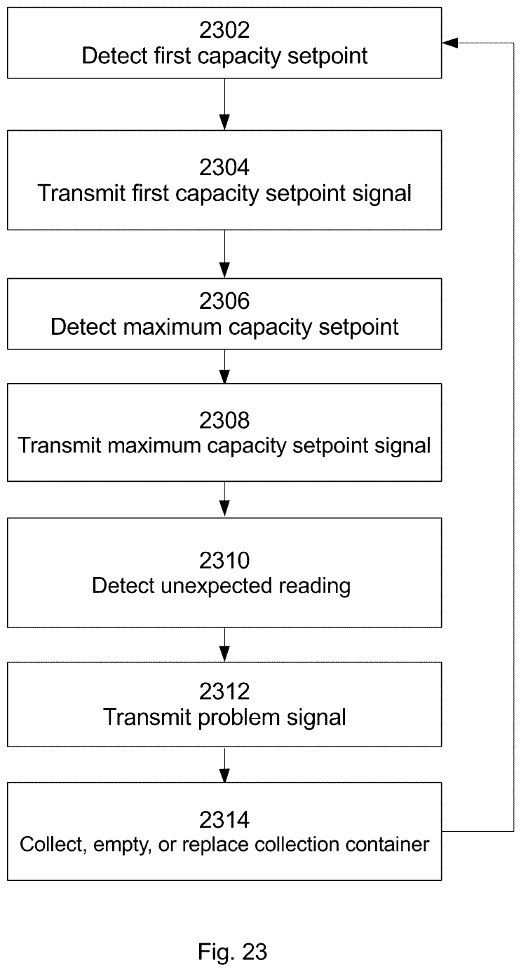

As shown in FIG. 23, the presently described device may be configured to operate a “Transmit Signal Program” concurrently with the Basic Program and/or the Alternation Program. The control system may detect a first capacity setpoint 2302. The first capacity setpoint is a concentration of target gas in a collection container which, if a third party responsible for collecting, emptying, or replacing the collection container were to leave upon receipt of a signal, would arrive when the collection container is at its maximum concentration capacity. The control system then transmits a first capacity setpoint signal to the third party 2304. If the control system detects a maximum capacity setpoint 2306, which is the maximum concentration which the collection container can or should reasonably and safely hold, it then transmits a maximum capacity setpoint signal to the third party 2308. If the control system detects an unexpected or problematic reading of any sensor, whether in the collection container or the sorption boxes 2310, then system will then transmit an inspection signal to the third party 2312 instructing the third party to inspect the present device for broken, damaged, or expired parts. An exemplary problematic reading may show a lack of decrease of a target gas concentration in a sorption box despite the operating of the ventilation system for that sorption box, which would indicate that the sorption unit of that sorption box has reached the end of its lifespan and must be replaced. The collection container is then collected, emptied, or replaced 2314, and the process repeats from the first step.

While the term “air” is used frequently throughout, and air generally contains about 78% nitrogen, 21% oxygen, and small amounts of other gases, too, it is understood that those amounts of other gases may increase, and that the air can be further contaminated with various toxic and/or flammable glasses, airborne pathogens, etc. As such, “air”, as used above, refers to air that may be in its general composition or contaminated with any gases or particles.

In one embodiment, system pressure is measured via a pressure sensor/gauge, transmitted to the controller, and compared to a pressure setpoint controlled by the controller. Based on the comparison (and optionally, other sensor feedback data), the controller may adjust various valves or other restrictions throughout the device. The restrictions may include fixed restrictions, such as Venturo or Orifice place, or variable restrictions, such as needle valves, which may be adjusted by the controller (i.e., slightly opened or slightly closed) based on the comparison in order to bring the measured pressure toward the pressure setpoint. Restrictions may be coupled with back pressure regulators or other restrictions. Pressure sensors, measured pressure, and the pressure setpoint may be features of sub-components of the system, such as reservoir tanks coupled to compressors.

In one embodiment, the inlet ventilation system may comprise a compressor or blower (i.e., a fan and pump), which may be connected to various ducts, including a dedicated duct inlet. The compressor may have additional air tanks to pressure air and gas mixtures. The system may also feature an outlet ventilation system (i.e., column effluent), comprising vacuum pumps and/or compressors, with pumped and/or comrpessed air configured to be released into an atmosphere or into a specific collection bag/containers.

Various filters may be disposed throughout the ventilation systems, including filters directed toward dust, smoke, humidity (water vapor), or various molecules (via membrane filters). In one variation, humidity control is accomplished via coupling humidity sensors, humidity setpoints, humidity filters, motarized valves, and the controller to direct the flow of air having a humidity level greater than the setpoint to be filtered via the humidity filters.

The collection bags/containers may be coupled to the system for receiving contaminated or exhaust air via valves, vacuum pumps, and/or compressors. In one configuration, a vacuum pump and a compressor may each be disposed on opposite sides of the collection bag/container and system engagement. In addition, the engagement may be measured or otherwise managed via flow meters, pressure sensors, additional compressors, and other ventilation components. In one variation, the collection bags/containers contain sorption materials.

In one embodiment, the system comprises a leak detection program to check the system for leaks. During this program, the various valves are opened and closed, with pressure sensors configured to detect pressure (and changes thereto) to determine whether there is any pressure lost with valves closed, etc. Determination of leaks result in notifications to relevant parties.

In one embodiment the system comprises a spiral-wound membrane module. Flat-sheet membranes are arranged into leaf-like envelopes separated by feed spacers and permeate spacers, then rolled about a central permeate collection tube. The feed stream flows axially along the channels formed by the feed spacers, while permeate passes through the membranes into the envelopes and spirals inward toward the collection tube. This configuration provides high membrane surface area per unit volume, suitable for compact gas separation applications.

In one embodiment the system comprises a hollow-fiber membrane module. Thousands of fine polymeric fibers are potted within a cylindrical pressure vessel. The feed stream may be introduced on the shell side of the fibers, with permeate collected at the bore side, or vice versa. The hollow-fiber geometry allows high packing density and minimal pressure drop, while providing scalability for industrial separations such as hydrogen recovery or carbon dioxide removal.

In one embodiment the system comprises a hollow-fiber sorbent contactor. In this embodiment, the hollow fibers comprise a porous wall impregnated or coated with adsorptive material such as zeolites, activated carbons, MOFs, or amine-functionalized polymers. Bundled into a shell-and-tube arrangement, the fibers act as a structured adsorbent bed with advantages including enhanced heat and mass transfer, low pressure drop, and improved stability against settling or channeling. Heating or cooling fluid may be circulated through the fiber lumens to control the heat of adsorption in PSA or TSA processes.

In one embodiment the system comprises a two types of adsorption units. On the left, a packed bed is shown as a column filled with granular adsorbent particles. On the right, a structured bed is shown in the form of monolithic blocks or hollow-fiber modules, providing an ordered flow path with reduced pressure drop and enhanced thermal management. Both packed and structured beds may be deployed as stand-alone adsorption units or integrated with membrane modules in hybrid systems.

In one embodiment the system comprises a hybrid gas separation system. The system comprises a membrane module, an adsorption stage, and a catalytic component arranged in sequence. In one embodiment, the membrane module provides bulk separation of a contaminant gas, the adsorption stage performs polishing removal of residual impurities, and the catalytic component promotes reaction of hydrogen or hydrocarbons. The arrows indicate feed gas entry, permeate discharge, and retentate flow through the system, showing continuous operation under a maintained pressure differential.

In one embodiment the system comprises a catalytic component configured for integration with the separation system. A ceramic or metallic lattice structure is coated with a catalytic metal oxide and a catalytic noble metal, such as platinum or palladium. A heating element may be incorporated to initiate or accelerate reactions at ambient conditions, while the lattice geometry provides mechanical strength and flow distribution. The catalytic component may be positioned upstream or downstream of the membrane or adsorption units depending on process requirements.

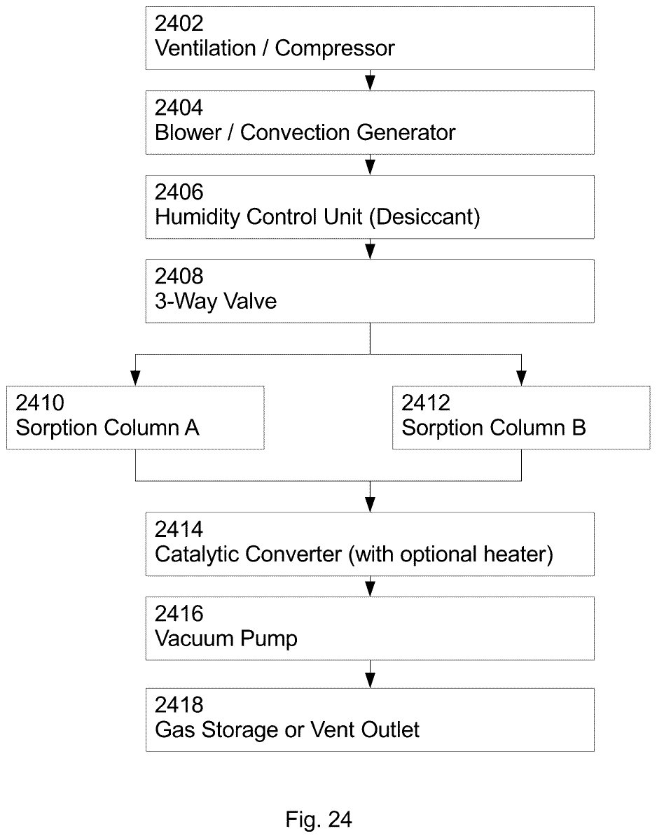

FIG. 24 illustrates an embodiment of a gas remediation device configured to remove flammable or toxic gases from ambient air. In this embodiment, ambient air enters the system through an inlet 2402 and is drawn into the device by a blower or compressor 2404, which functions as a pressure differential convection generator. The gas stream then passes through a humidity control unit 2406 containing a desiccant material such as silica gel or zeolite for removal of water vapor. Downstream of the humidity control unit, a valve 2408 directs the gas stream to one or more sorption columns, including a first sorption column 2410 and a second sorption column 2412. The sorption columns contain sorbent materials configured to adsorb target gases such as carbon monoxide or hydrocarbons.

Gas exiting the sorption columns may be directed to a catalytic converter 2414 configured to oxidize hydrogen or other flammable gases, optionally using a heater 2422 to facilitate catalytic reactions. A vacuum pump 2416 may be coupled to the system to assist in regeneration of the sorption columns or to remove desorbed gas species. The desorbed gases may be directed to a storage container or vent outlet 2418 for controlled release or disposal.

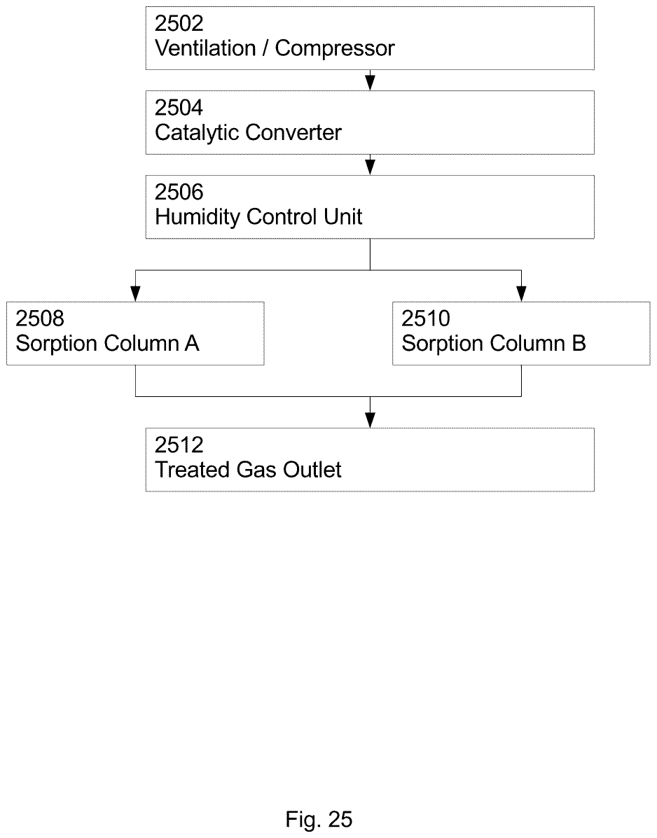

FIG. 25 illustrates an embodiment of a gas remediation system configured to remove flammable gases and carbon dioxide from an ambient air stream. In this embodiment, an incoming gas stream enters the device through a ventilation or compression unit 2502 that draws ambient air into the system. The incoming gas stream may include a mixture of air and flammable gases such as methane, hydrogen, or carbon monoxide.

The gas stream is directed to a catalytic converter 2504 configured to oxidize flammable gases. In certain embodiments the catalytic converter may include a heater configured to facilitate catalytic oxidation of hydrogen according to the reaction:
2H₂+O₂→2H₂O+heat.

In some embodiments methane or other hydrocarbons may also be oxidized according to the reaction:
CH₄+2O₂→CO₂+2H₂O.

The gas stream exiting the catalytic converter may then pass through a humidity control unit 2506 configured to remove water vapor produced during catalytic reactions. The humidity control unit may include desiccant materials such as zeolites, activated alumina, or other adsorbent materials configured to reduce water content in the gas stream.

After humidity removal, the gas stream may be directed to one or more sorption columns 2508 and 2510 configured to adsorb carbon dioxide or other gases. In certain embodiments the sorption columns may operate at elevated temperature and may include sorbent materials such as calcium oxide, magnesium oxide, or other high-temperature carbon dioxide sorbents configured to capture carbon dioxide at low partial pressures.

Gas exiting the sorption columns may then be discharged from the system as a treated gas stream. In certain embodiments the treated stream may consist primarily of nitrogen and residual air components and may be safely vented to the surrounding environment.

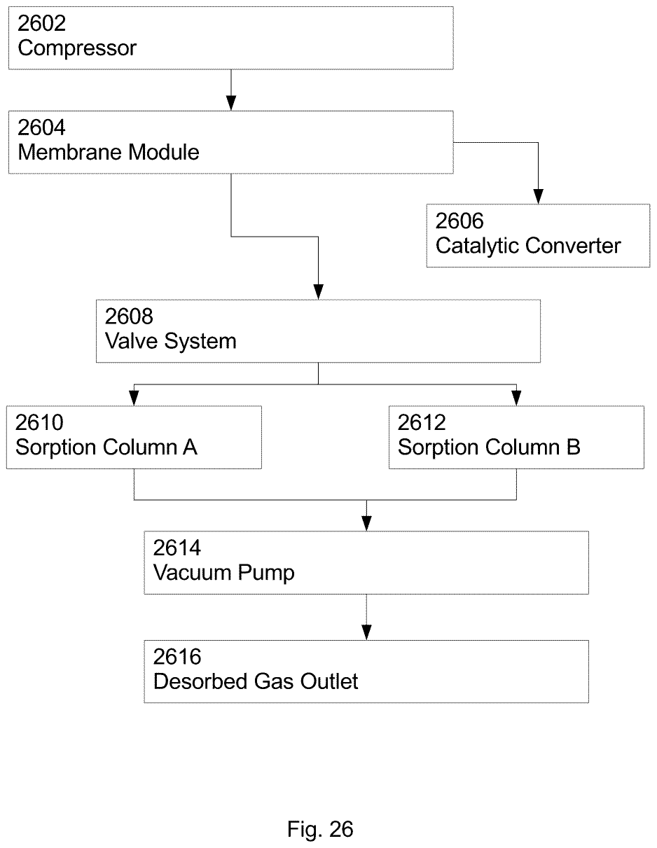

FIG. 26 illustrates another embodiment of a gas remediation system configured to process a gas stream containing air and one or more additional gases (such as battery gas leaks). In this embodiment, an incoming gas stream enters the device through a compressor 2602 that draws the gas mixture into the system. The incoming stream may include air mixed with hydrogen, methane, carbon monoxide, or other gases.

The compressed gas stream may then be directed to a membrane separation module 2604. In certain embodiments the membrane module may include hollow fiber membranes configured to separate hydrogen or other gases from the incoming stream. A permeate stream may pass through the membrane while a retentate stream continues through the system.

In some embodiments the permeate stream may be directed to a catalytic converter 2606 configured to oxidize hydrogen according to the reaction:
2H₂+O₂→2H₂O.

The resulting water vapor may be vented to the surrounding environment.

The retentate stream from the membrane module may be directed through a valve system 2608 to one or more sorption columns 2610 and 2612. The sorption columns may contain sorbent materials configured to adsorb gases such as carbon dioxide or hydrocarbons from the gas stream.

In certain embodiments the sorption columns may operate in alternating cycles. While one column is adsorbing gases from the incoming stream, another column may be regenerated.

Regeneration of the sorption material may be performed by applying vacuum using a vacuum pump 2614 connected through one or more valves. Desorbed gases may be directed via an outlet 2616 to a storage container, vented outdoors, or optionally directed to a catalytic converter for oxidation before discharge.

The treated gas stream exiting the sorption columns may be discharged from the device as an air stream that may be returned to the surrounding environment.

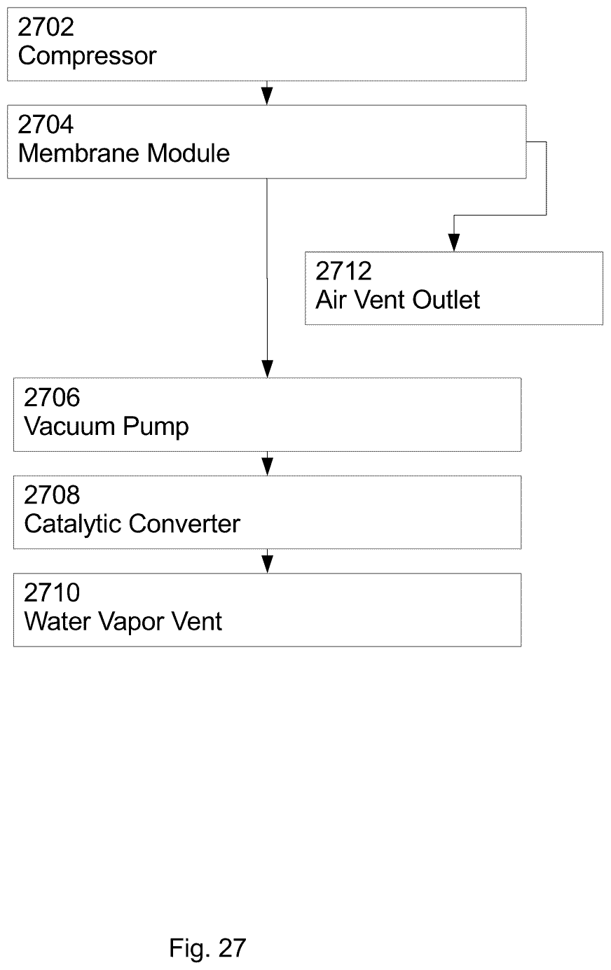

FIG. 27 illustrates another embodiment of a gas remediation system configured to process a gas stream including hydrogen and air. A gas mixture enters the system through a compressor 2702, which directs the gas stream into a membrane separation module 2704.

The membrane separation module may include hollow fiber membranes configured to separate hydrogen from the incoming gas stream. A permeate stream containing hydrogen may pass through the membrane and be directed toward a vacuum pump 2706 configured to draw the permeate gas through the membrane module.

The hydrogen-containing stream may then be directed to a catalytic converter 2708 configured to oxidize hydrogen according to the reaction:
2H₂+O₂→2H₂O

The resulting water vapor may be vented from the system through outlet 2710.

A retentate stream exiting the membrane module may consist primarily of air and may be discharged from the system through vent outlet 2712.

In some embodiments, the system includes a hydrogen fluoride (HF) control module positioned upstream of one or more downstream gas-treatment components. The HF control module is configured to remove hydrogen fluoride from a gas stream by contacting the gas stream with a solid HF-reactive material capable of converting hydrogen fluoride into stable fluoride compounds.

In one embodiment, the HF control module is implemented as a packed sorbent bed contained within a vessel or cartridge housing. The housing may define a gas inlet and a gas outlet and contain a quantity of particulate sorbent material through which the gas stream flows. As the gas passes through the packed sorbent material, hydrogen fluoride present in the gas reacts with the sorbent and is converted to a stable solid fluoride retained within the bed.

Suitable sorbent materials may include alkaline or metal oxide materials capable of reacting with hydrogen fluoride, including calcium oxide (CaO), calcium hydroxide (Ca(OH)₂), magnesium oxide (MgO), calcined dolomite, activated alumina (Al₂O₃), mixed magnesium-aluminum oxides, cerium oxide (CeO₂), or combinations thereof. For example, CaO or Ca(OH)₂ may react with hydrogen fluoride to form calcium fluoride (CaF₂), while activated alumina may chemisorb HF to form aluminum fluoride (AlF₃) and water. These reactions convert gaseous HF into stable solid fluoride salts retained within the sorbent material.

Although a packed sorbent bed provides one implementation, the HF control module may also comprise other gas-contacting structures containing HF-reactive material. For example, the HF control module may comprise:
a packed sorbent bed contained within a vessel or cartridge;
a replaceable cartridge or filter element containing particulate HF-reactive media;
a structured sorbent element, such as a honeycomb or monolithic substrate coated with HF-reactive material;
a porous or fibrous filter medium impregnated with HF-reactive compounds;
a granular or pelletized sorbent container through which the gas stream flows; or
other structures configured to provide gas-solid contact between the gas stream and an HF-reactive material.

In each of these implementations, the HF control module provides a gas-flow path through or across a solid HF-reactive medium, allowing hydrogen fluoride to react with or be adsorbed by the material and thereby be removed from the gas stream.

In some embodiments, the HF control module is positioned as a guard stage upstream of other system components, such as sorption columns, catalytic converters, or membrane separation modules. Locating the HF control module upstream may protect downstream components from corrosive or catalyst-poisoning acidic gases.

The HF control module may be configured to treat gas mixtures that include ambient air together with battery vent gases, such as gases released during battery off-gas events, thermal runaway events, or post-fire conditions. In such environments, hydrogen fluoride may be present together with flammable gases and air. The sorbent materials described above may rapidly react with HF under these conditions, thereby removing HF from the gas stream before the gas stream reaches downstream gas-treatment stages.

In some embodiments, the HF control module may be implemented as a replaceable cartridge or refillable vessel, allowing the HF-reactive sorbent material to be replaced once reaction with hydrogen fluoride reduces the sorbent capacity.

In some embodiments, the system includes a hydrogen sulfide (H₂S) control module positioned upstream of one or more downstream gas-treatment components. The hydrogen sulfide control module is configured to remove hydrogen sulfide from a gas stream by contacting the gas stream with a solid material capable of reacting with or adsorbing hydrogen sulfide.

In one embodiment, the hydrogen sulfide control module is implemented as a packed sorbent bed contained within a vessel or cartridge housing. The housing may define a gas inlet and a gas outlet and contain a quantity of particulate sorbent material through which the gas stream flows. As the gas passes through the packed sorbent material, hydrogen sulfide present in the gas reacts with or is adsorbed by the sorbent material and is retained within the bed.

Suitable sorbent materials may include metal oxides, metal hydroxides, or other compounds capable of reacting with hydrogen sulfide, including iron oxide (Fe₂O₃), iron hydroxide, zinc oxide (ZnO), copper oxide (CuO), manganese oxide, activated carbon impregnated with metal compounds, or combinations thereof. For example, hydrogen sulfide may react with iron oxide to form iron sulfide (FeS), or with zinc oxide to form zinc sulfide (ZnS). These reactions convert gaseous hydrogen sulfide into stable solid sulfide compounds retained within the sorbent material.

Although a packed sorbent bed provides one implementation, the hydrogen sulfide control module may also comprise other gas-contacting structures containing H₂S-reactive material. For example, the hydrogen sulfide control module may comprise:
a packed sorbent bed contained within a vessel or cartridge;
a replaceable cartridge or filter element containing H₂S-reactive media;
a structured sorbent element, such as a honeycomb or monolithic substrate coated with H₂S-reactive material;
a porous or fibrous filter medium impregnated with metal oxide or other H₂S-reactive compounds;
a granular or pelletized sorbent container through which the gas stream flows; or
other structures configured to provide gas-solid contact between the gas stream and a hydrogen sulfide-reactive material.

In each of these implementations, the hydrogen sulfide control module provides a gas-flow path through or across a solid H₂S-reactive medium, allowing hydrogen sulfide to react with or be adsorbed by the material and thereby be removed from the gas stream.

In some embodiments, the hydrogen sulfide control module is positioned as a guard stage upstream of other system components, such as sorption columns, catalytic converters, membrane separation modules, or other gas-treatment elements. Locating the hydrogen sulfide control module upstream may protect downstream components from corrosive or catalyst-poisoning sulfur-containing gases.

The hydrogen sulfide control module may be configured to treat gas mixtures containing ambient air together with battery vent gases or other industrial gas streams in which hydrogen sulfide may be present. In such environments, the sorbent materials described above may rapidly react with hydrogen sulfide, thereby removing the gas from the stream before it reaches downstream gas-treatment stages.

In some embodiments, the hydrogen sulfide control module may be implemented as a replaceable cartridge or refillable vessel, allowing spent sorbent material to be replaced once reaction with hydrogen sulfide reduces the sorbent capacity.

In some embodiments, the system includes a catalytic module configured to oxidize combustible gases present in a gas stream. The catalytic module may comprise a reactor housing containing a catalyst supported on a gas-permeable substrate, through which the gas stream flows. As the gas stream passes through the catalytic module, combustible gases are oxidized on the catalyst surface.

The catalytic module may include a flow-through reactor structure comprising a housing defining a gas inlet and a gas outlet and containing a catalyst-support structure positioned within the housing. The catalyst-support structure may be configured to permit gas flow through or across the catalyst while providing a large surface area for catalytic reactions.

Suitable catalyst-support structures may include open-cell metal foams, ceramic monolith substrates, honeycomb structures, porous metallic structures, or packed beds of catalyst particles. For example, the catalyst-support structure may comprise an open-cell nickel foam or iron-chromium-aluminum alloy foam, or a ceramic honeycomb monolith such as a cordierite substrate. These structures may allow the gas stream to pass through the substrate while exposing the gas to catalyst deposited on the substrate surfaces.

In some embodiments, the catalyst-support structure may include a washcoated monolith, in which a catalytic material is deposited onto a porous coating applied to the substrate surface. The coating may include materials such as aluminum oxide or other high-surface-area oxides capable of supporting catalytic metals.

The catalyst present in the catalytic module may comprise noble metal catalysts, transition metal catalysts, or combinations thereof capable of promoting oxidation reactions. In some embodiments, the catalyst may comprise bimetallic catalysts including combinations of platinum with cobalt, nickel, or palladium, such as Pt—Co, Pt—Ni, or Pd—Ni catalysts supported on aluminum oxide or other catalyst supports. In one example embodiment, a catalyst may comprise approximately 1% platinum and 1% cobalt supported on an alumina support material.

Catalysts may be deposited onto the support structure using techniques such as impregnation, incipient wetness deposition, co-deposition, galvanic replacement, washcoating, or other catalyst deposition methods known in the art.

In operation, a gas stream containing combustible gases may flow through the catalytic module and contact the catalyst surfaces. In the presence of oxygen, combustible gases such as hydrogen may be oxidized according to reactions such as:
2H₂+O₂→2H₂O

The catalytic module may therefore convert hydrogen and other combustible gases into non-flammable reaction products such as water vapor and carbon dioxide.

In some embodiments, the catalytic module may include temperature control elements configured to maintain the catalyst at a temperature suitable for catalytic activity. For example, the catalytic module may include one or more resistive heating elements positioned adjacent to the catalyst-support structure, thermocouples or temperature sensors configured to monitor catalyst temperature, and a controller configured to regulate heater operation.

The catalytic module may be positioned within the system downstream of other gas treatment components and upstream of an outlet or downstream processing stage. In some embodiments, the catalytic module may receive gas streams that have passed through sorption modules, membrane modules, or other gas-processing stages.

In some embodiments, the catalytic module may be configured to process gas mixtures including ambient air and battery vent gases, such as gases produced during battery off-gas events, thermal runaway events, or post-fire conditions. Under such conditions, hydrogen present in the gas stream may be catalytically oxidized in the catalytic module.

The catalytic module may be implemented as a replaceable reactor cartridge or a permanently installed reactor vessel, and may be configured so that the catalyst-support structure can be removed and replaced after catalyst degradation or contamination.

1. An enclosed flammable or toxic gas remediation device comprising:
a. an enclosure configured to enclose portions of the enclosed flammable or toxic gas remediation device against an atmosphere, with the atmosphere being external to the enclosed flammable or toxic gas remediation device;
b. a set of sensors configured to detect gas concentration in the atmosphere external to the enclosure;
c. a control device, with the control device being in informational engagement with the set of gas, temperature and humidity sensors and control engagement with a set of valves, a pressure differential convection generator, and relays in order to alternate between a first and second program;
d. the pressure differential convection generator to direct gas dispersed in ambient air from gas leaks in the atmosphere via an incoming stream through the device, with the pressure differential generator comprising a pump, blower, or compressor and configured to run when a target concentration of a flammable or toxic gas in the atmosphere is reached;
i. where the pressure differential convection generator comprises a set of inlets, with the inlets configured to be oriented toward an expected gas dispersion pattern
e. a humidity control unit positioned upstream from a first and second sorption module, with the humidity control unit configured to remove ambient water vapor or relative humidity;
f. the first and second sorption modules each configured to adsorb one or more flammable or toxic target gases from the incoming stream;
i. with the first and second sorption modules controlled by the first program and the second program;
ii. under the first program the incoming stream flows to the first sorption module but not the second module;
iii. under the second program the incoming stream flows to the second sorption module but not the first sorption module;
g. an outlet positioned downstream from the humidity control unit, the pressure differential convection generator, and the first and second sorption modules, with the outlet configured to recycle ambient air from the enclosure back into the atmosphere;
h. with the humidity control unit, the first and second sorption modules, and the pressure differential generator disposed within the enclosure;
i. wherein the enclosure is configured to operate under controlled pressure conditions relative to the atmosphere.

2. The device of claim 1, wherein
a. the first program configured to transition to the second program when the gas concentration in ambient air within the atmosphere ceases decreasing;
b. the second program configured to transition to the first program when the gas concentration in ambient air within the atmosphere ceases decreasing;
c. microwave irradiation is not used for regenerating sorption materials.

3. The device of claim 1, additionally comprising a catalytic module and an HF module or hydrogen sulfide module;
a. the catalytic module and HF module or hydrogen sulfide module both being disposed inside the enclosure;
b. the HF module or hydrogen sulfide module being positioned upstream from the pressure differential convection generator;
c. the humidity control unit positioned downstream from the HF module or hydrogen sulfide module;
d. the catalytic module positioned downstream of the first and second sorption modules, the catalytic module configured to oxidize flammable or toxic gases;
e. the catalytic module comprising an outlet, with the outlet of the catalytic module configured to release an outgoing stream of ambient air back into the atmosphere.

4. The device of claim 3, with the catalytic module comprising a heater;
a. with the device further comprising a control logic unit configured to automatically activate or deactivate the heater based on gas composition in ambient air, wherein the heater is activated when the gas composition in ambient air comprises hydrocarbons, and when activated also promotes oxidation of hydrogen;
b. with the control logic unit additionally configured to activate the heater based on a gas leak flow rate into the atmosphere;
c. with the control logic unit additionally configured to control heater temperature based on the gas leak flow rate into the atmosphere.

5. The device of claim 4, wherein the heater is configured to activate upon detection of flammable or toxic gases in the enclosed atmosphere.

6. The device of claim 1, further comprising a collection container connected to receive outflow from the first and second sorption modules, wherein the collection container is configured to retain separated or desorbed flammable or toxic gas species, with the collection container comprising a release control mechanism for regulating pressure and controllably releasing the stored separated or desorbed gas species.

7. The device of claim 1, with the pressure differential convection generator comprising a compressor or blower, with the compressor or blower positioned upstream of the humidity control unit.

8. The device of claim 1, with the pressure differential convection generator comprising a vacuum pump, with the vacuum pump positioned downstream of the first and second sorption modules and upstream of a collection container.

9. An enclosed flammable or toxic gas remediation device comprising:
a. an enclosure configured to enclose portions of the gas remediation device against an atmosphere, with the atmosphere being external to the enclosed gas remediation device;
b. a catalytic module configured to oxidize flammable or toxic gases dispersed in ambient air from gas leaks within the atmosphere;
c. a first and second humidity control unit;
i. the first humidity control unit positioned upstream of the catalytic module;
ii. the second humidity control unit positioned downstream of the catalytic module and upstream of a first and second sorption modules;
iii. the second humidity control unit configured to remove water vapor produced by the catalytic module;
iv. the first humidity control unit configured to remove ambient water vapor or relative humidity from the atmosphere;
d. first and second sorption modules, the first and second sorption modules being positioned downstream of the catalytic module and configured to adsorb carbon dioxide generated by the catalytic module;
e. a pressure differential convection generator to direct an incoming stream from ambient air through the device;
i. where the incoming stream comprises at least two of hydrogen, carbon monoxide, methane, water vapor, and air;
f. where the pressure differential convection generator comprises a set of inlets, with the inlets configured to be oriented toward an expected gas dispersion pattern;
g. an outlet positioned downstream from the first and second humidity control units, the pressure differential convection generator, and the first and second sorption modules, with the outlet configured to recycle ambient air from the enclosure back into the atmosphere;
h. with the first and second sorption modules disposed within the enclosure, wherein the enclosure is configured to operate under controlled pressure conditions relative to the atmosphere.

10. The device of claim 9, wherein at least one of the first and second sorption modules are configured to chemisorb or physisorb carbon dioxide.

11. The device of claim 10, wherein the catalytic module is configured to oxidize flammable or toxic gases into water vapor, or water vapor and carbon dioxide.

12. The device of claim 10, with the catalytic module comprising a heater, with the device further comprising a control logic unit configured to automatically activate or deactivate the heater based on gas composition in ambient air from gas leaks within the atmosphere, wherein the heater is activated when the gas composition in ambient air comprises hydrocarbons or hydrogen, and when activated also promotes oxidation of hydrogen.

13. The device of claim 12, with the control logic unit additionally configured to activate the heater based on a gas leak flow rate into the atmosphere;
a. with the control logic unit additionally configured to control heater temperature based on the gas leak flow rate into the atmosphere.

14. The device of claim 9, further comprising an HF module or a hydrogen sulfide module positioned within the enclosure and upstream of the pressure differential convection generator.

15. The device of claim 9, further comprising a membrane module comprising at least one hollow fiber bundle or spiral-wound element configured to selectively permeate a target flammable or toxic gas species from ambient air, wherein membrane separation performance precedes gas and air flow into the catalytic module, wherein the membrane module operates under a pressure differential generated by a compressor, blower, vacuum pump, or valves.

16. The device of claim 15, wherein the catalytic module is configured to convert hydrogen into water vapor, thereby reducing hydrogen concentration after membrane separation.

17. An enclosed gas remediation device comprising:
a. an enclosure configured to enclose portions of the gas remediation device against an atmosphere, with the atmosphere being external to the enclosed gas remediation device;
b. a pressure differential convection generator configured to move gas dispersed in ambient air from the atmosphere into the enclosed gas remediation device via an incoming stream;
c. a humidity control unit configured to remove water vapor from ambient air in the atmosphere and disposed downstream of the pressure differential convection generator;
d. a membrane module disposed downstream of the humidity control unit;
e. a catalytic module positioned downstream of the membrane module and configured to receive a membrane module permeate and oxidize flammable or toxic gases;
f. a control logic unit coupled to a first and second set of gas sensors;
i. with the first set of gas sensors being disposed within the enclosure and the second set of gas sensors being disposed without the enclosure;
ii. with the control logic unit configured to activate the compressor or blower based on gas concentration in ambient air from gas leaks within the atmosphere detected by the second set of gas sensors;
iii. with the control logic unit configured to operate valves or activate pressure regulators within the device;
iv. with the control logic unit configured to activate a heater based on the gas concentration in the atmosphere and leak flow rate;
g. an outlet positioned downstream from the humidity control unit, the pressure differential convection generator, the catalytic module, and the membrane module, with the outlet configured to recycle ambient air from the enclosure back into the atmosphere;
h. wherein the membrane module operates under a pressure differential generated by a compressor or blower;
i. wherein the enclosure is configured to operate under controlled pressure conditions relative to the atmosphere.

18. The device of claim 17, where the membrane module comprising at least one hollow fiber bundle.

19. The device of claim 17, additionally comprising a sorption module, the sorption module positioned downstream of the membrane module, disposed within the enclosure, and configured to receive a membrane module retentate stream.

20. The device of claim 17, additionally comprising a vacuum pump disposed between the membrane module and the catalytic module.
